(19) United States
(12) Patent Application Publication
(10) Pub. No.: US 2020/0063597 A1
(43) Pub. Date: Feb. 27, 2020

(54) VARIABLE-STATOR-VANE ACTUATION SYSTEM

(71) Applicant: WILLIAMS INTERNATIONAL CO., L.L.C., Pontiac, MI (US)

(72) Inventor: Daniel G. H. SORAOKA, West Haven, UT (US)

(73) Assignee: WILLIAMS INTERNATIONAL CO., L.L.C., Pontiac, MI (US)

(21) Appl. No.: 16/539,837

(22) Filed: Aug. 13, 2019

Related U.S. Application Data
(60) Provisional application No. 62/718,201, filed on Aug. 13, 2018.

(51) Int. Cl. F01D 17/16; F02C 9/22

(52) U.S. Cl. CPC F01D 17/162; F02C 9/22

(57) ABSTRACT

A first actuator provides for rotating—responsive to a first actuator—a coupler subassembly about a first rotational axis defined by at least one first pivot axis. The coupler subassembly incorporates a plurality of link-coupler portions and one or more second actuators, wherein each second actuator is operative on at least one link-coupler portion of a corresponding pair of link-coupler portions so as to provide for a relative motion of at least one link-coupler portion that is either additive to, or subtractive from, the corresponding motion responsive to the first actuator.

### CROSS-REFERENCE TO RELATED APPLICATIONS

The instant application claims the benefit of prior U.S. Provisional Application Ser. No. 62/718,201 filed on 13 Aug. 2018, which is incorporated herein by reference in its entirety.

### BRIEF DESCRIPTION OF THE DRAWINGS

In the accompanying drawings:

FIG. 1 illustrates a gas-turbine engine incorporating a plurality of stages of variable stator vanes, wherein the rotational angles of the variable stator vanes are controlled by an associated variable-stator-vane actuation system;

FIG. 2 illustrates two stages of variable stator vanes and an associated variable-stator-vane adjustment mechanism of a prior-art gas-turbine engine;

FIG. 3 illustrates a first aspect of a variable-stator-vane actuation system, wherein the relative upstream and downstream locations are juxtaposed from those illustrated in FIG. 1;

FIG. 4 illustrates a first radial cross-sectional view of the first aspect of the variable-stator-vane actuation system illustrated in FIG. 3, with the associated cutting plane through an actuator rod of an associated linear actuator, and through an associated joint coupling the actuator rod to an associated segment of a tubular coupler;

FIG. 5 illustrates a second radial cross-sectional view of the first aspect of the variable-stator-vane actuation system illustrated in FIG. 3, with the associated cutting plane through a disk operatively coupling a rotational-positioning-actuator rotor shaft to an associated segment of the tubular coupler, and through an associated joint coupling an associated variable-stator-vane turnbuckle link to the associated segment of the tubular coupler;

FIG. 6 illustrates a third radial cross-sectional view of the first aspect of the variable-stator-vane actuation system illustrated in FIG. 3, with the associated cutting plane through each of the rotational-positioning-actuator rotor shaft, a tang depending from the disk, and a plurality of associated stops operatively coupled to an associated adjacent segment of the tubular coupler;

FIG. 7 illustrates a fourth radial cross-sectional view of the first aspect of the variable-stator-vane actuation system illustrated in FIG. 3, with the associated cutting plane through an associated joint coupling an associated variable-stator-vane turnbuckle link to a downstream-most segment of the tubular coupler;

FIG. 8 illustrates a second aspect of a variable-stator-vane actuation system;

FIG. 9 illustrates a first radial cross-sectional view of the second aspect of the variable-stator-vane actuation system illustrated in FIG. 8, with the associated cutting plane through a disk operatively coupling a rotational-positioning-actuator rotor shaft to an associated segment of a tubular coupler, and through an associated joint coupling an associated variable-stator-vane turnbuckle link to the associated segment of the tubular coupler;

FIG. 10 illustrates a second radial cross-sectional view of the second aspect of the variable-stator-vane actuation system illustrated in FIG. 8, with the associated cutting plane through each of the rotational-positioning-actuator rotor shaft, a tang depending from the disk, and a plurality of associated stops operatively coupled to an associated adjacent segment of the tubular coupler;

FIG. 11 illustrates a third radial cross-sectional view of the second aspect of the variable-stator-vane actuation system illustrated in FIG. 8, with the associated cutting plane through an associated joint coupling an associated variable-stator-vane turnbuckle link to a downstream-most segment of the tubular coupler;

FIG. 12 illustrates a third aspect of a variable-stator-vane actuation system;

FIG. 13 illustrates a first radial cross-sectional view of the third aspect of the variable-stator-vane actuation system illustrated in FIG. 12, with the associated cutting plane through an associated joint coupling an associated variable-stator-vane turnbuckle link to an upstream-most portion of a tubular frame;

FIG. 14 illustrates a second radial cross-sectional view the third aspect of the variable-stator-vane actuation system illustrated in FIG. 12, with the associated cutting plane through a tang depending from an arm operatively coupling a rotational-positioning-actuator rotor shaft to an associated variable-stator-vane turnbuckle link, and through a plurality of associated stops operatively coupled to the tubular frame.

FIG. 15 illustrates the third radial cross-sectional view of the third aspect of the variable-stator-vane actuation system illustrated in FIG. 12, with the associated cutting plane through the arm operatively coupling the rotational-positioning-actuator rotor shaft to an associated variable-stator-vane turnbuckle link via an associated joint;

FIG. 16 illustrates a fourth aspect of a variable-stator-vane actuation system;

FIG. 17 illustrates a fifth aspect of a variable-stator-vane actuation system;

FIG. 18 illustrates a representation of the fifth aspect of the variable-stator-vane actuation system with each of the associated links aligned with one another, and with the associated spherical rod ends of the turnbuckles aligned with one another and with the pivots between the links, without displacement of the associated linear actuator;

FIG. 19 illustrates a perturbation of the configuration illustrated in FIG. 18, with the link subassembly rotated by the linear actuator;

FIG. 20 illustrates a perturbation of the configuration illustrated in FIG. 19, with the link subassembly rotated by the linear actuator, and with each of the associated links rotated by a uniform positive angle relative to one another;

FIG. 21 illustrates a perturbation of the configuration illustrated in FIG. 19, with the link subassembly rotated by the linear actuator, and with each of the associated links rotated by a uniform negative angle relative to one another;

FIG. 22 illustrates a composite of the configurations illustrated in FIGS. 18-21;

FIGS. 23a and 23b respectively illustrate a top view and a side cross-sectional view of a first embodiment of a spherical rod end of an associated turnbuckle link, operatively coupled to an associated coupler subassembly;

FIGS. 24a and 24b respectively illustrate a top view and a side cross-sectional view of a second embodiment of a spherical rod end of an associated turnbuckle link, operatively coupled to an associated coupler subassembly;

FIGS. 25a and 25b respectively illustrate a top and side views of a first embodiment of a one-rotational-degree-of-freedom joint connecting an associated turnbuckle link to an associated coupler subassembly;

FIGS. 26a and 26b respectively illustrate a top and side views of a second embodiment of a one-rotational-degree-of-freedom joint connecting an associated turnbuckle link to an associated coupler subassembly;

FIG. 27 illustrates an isometric side-cross-sectional view of a rotational-positioning actuator and an associated planetary-gear train and joint configured for application to coupler subassembly of either of the first or second aspects of the variable-stator-vane actuation system;

FIG. 28 illustrates a side-cross-sectional view of a rotational-positioning actuator and an associated planetary-gear train illustrated in FIG. 27;

FIG. 29 illustrates an isometric view of a rotational-positioning actuator and an associated planetary-gear train and joint configured for application to coupler subassembly of the fifth aspect of the variable-stator-vane actuation system;

FIG. 30 illustrates a first side-cross-sectional view of a rotational-positioning actuator and an associated planetary-gear train and joint illustrated in FIG. 29;

FIG. 31 illustrates a second side-cross-sectional view of a rotational-positioning actuator and an associated planetary-gear train and joint illustrated in FIG. 29;

FIG. 32 illustrates a split coupler that can be incorporated in the fifth aspect of the variable-stator-vane actuation system to provide for a uniform projected length of the associated coupler assembly, independent of the positions of the associated actuators;

FIG. 33 illustrates the split coupler of FIG. 32, with the associated coupler link portions of the coupler slidaeably fully engaged with one another responsive to a first state of articulation of the associated joints; and

FIG. 34 illustrates the split coupler of FIG. 32, with the associated coupler link portions of the coupler slidaeably partially extended relative to one another responsive to a second state of articulation of the associated joints.

### DESCRIPTION OF EMBODIMENT(S)

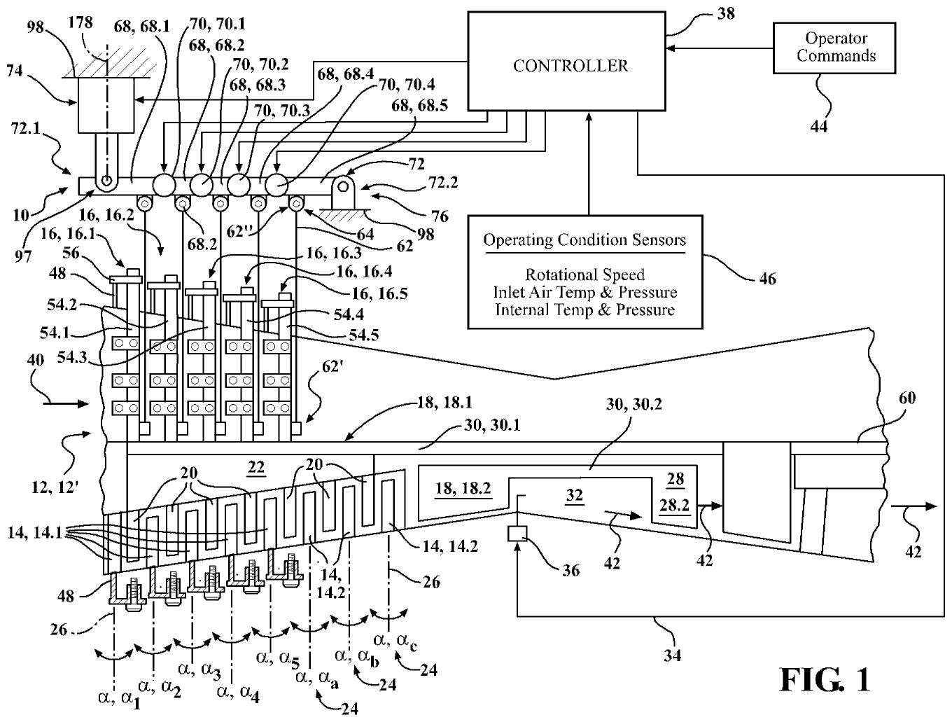

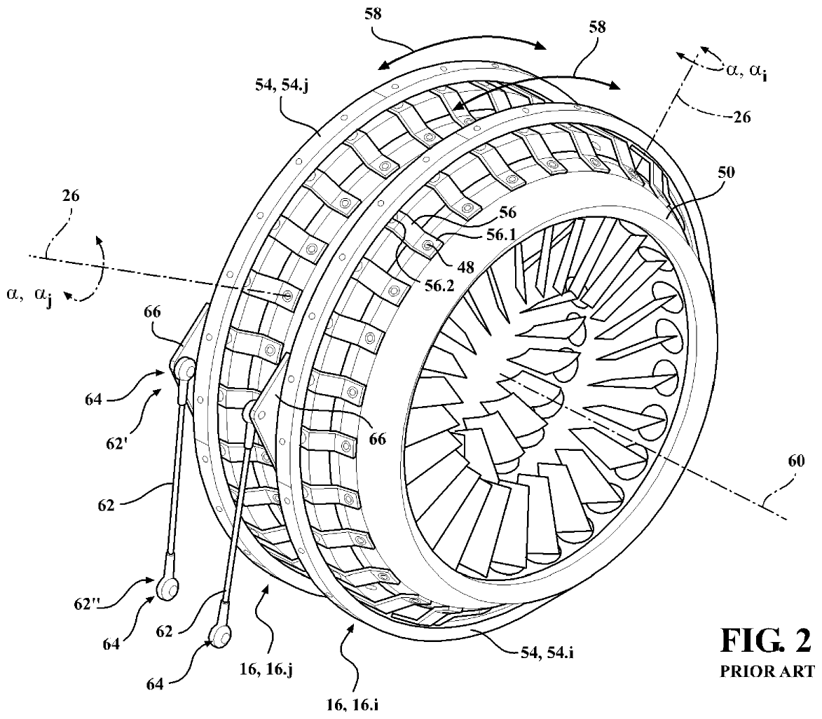

Referring to FIGS. 1 and 2, a variable-stator-vane actuation system 10 is incorporated in a gas-turbine engine 12—for example, a two-spool gas-turbine engine 12, 12′—to provide for controlling the rotational angles α, αᵢ, αⱼ of each of a plurality of variable stator vanes 14, 14.1 of each of a plurality of variable-stator-vane stages 16, 16.1, 16.2, 16.3, 16.4, 16.5, 16.i, 16.j. The variable stator vanes 14, 14.1 are incorporated in an associated compressor 18—for example, a low-pressure compressor 18, 18.1—of the gas-turbine engine 12, in cooperation with corresponding sets of fixed blades 20 depending from the associated rotor 22 of the compressor 18. The compressor 18 may also include an additional plurality of fixed stator vanes 14, 14.2 of a corresponding one or more fixed-stator-vane stages 24—downstream of the variable-stator-vane stages 16.1, 16.2, 16.3, 16.4, 16.5, 16.i, 16.j—in cooperation with additional fixed blades 20 depending from the rotor 22 of the compressor 18, wherein the fixed stator vanes 14, 14.2 are each at a corresponding fixed rotational angle α, αₐ, α_{b}, α_{c} that can be different for different fixed-stator-vane stages 24. The rotational angles α of the corresponding associated variable 14.1 or fixed 14.2 stator vane 14 are each measured with respect to a corresponding generally-radial axis 26 of the variable 14.1 or fixed 14.2 stator vane 14, relative to an arbitrary angular reference.

The compressor 18, 18.1 is operatively coupled to, and driven by, a corresponding turbine 28—for example, a corresponding low-pressure turbine 28, 28.1,—both of which together constitute a corresponding spool 30 of the gas-turbine engine 12—for example, a corresponding low-pressure spool 30, 30.1. The two-spool gas-turbine engine 12, 12′ illustrated in FIG. 1 further incorporates a high-pressure spool 30, 30.2 comprising a high-pressure compressor 18, 18.2 and an associated high-pressure turbine 28, 28.2 that together span an associated combustion chamber 32 of the two-spool gas-turbine engine 12, 12′.

In accordance with the Brayton thermodynamic cycle, during operation of the gas-turbine engine 12, 12′, fuel 34 injected into the combustion chamber 32 by an associated fuel-injection system 36 under control of an associated controller 38, is combined and continuously combusted with air 40 pumped into the gas-turbine engine 12, 12′ by the low-pressure compressor 18, 18.1, further compressed by the high-pressure compressor 18, 18.2, and then discharged thereby and therefrom into the combustion chamber 32. The resulting exhaust products 42 drive the high-pressure turbine 28, 28.2 that in turn directly drives the high-pressure compressor 18, 18.2, and the exhaust products 42 discharged from the high-pressure turbine 28, 28.2 drive the low-pressure turbine 28, 28.1 that in turn directly drives the low-pressure compressor 18, 18.1.

The amount of fuel 34 injected by the fuel-injection system 36 and the particular rotational angles α, α₁, α₂, α₃ α₄, α₅, αᵢ, αⱼ of the variable stator vanes 14, 14.1 of the associated variable-stator-vane stages 16.1, 16.2, 16.3, 16.4, 16.5, 16.i, 16.j is responsive to one or more operator commands 44 in combination with inputs from one or more operational condition sensors 46 responsive to one or more of the rotational speed of the gas-turbine engine 12, 12′, the associated inlet air conditions, i.e. temperature and/or pressure, or temperatures and/or pressures within the gas-turbine engine 12, 12′. The number of variable-stator-vane stages 16.1, 16.2, 16.3, 16.4, 16.5, 16.i, 16.j—at least two—will depend upon the particular application of the gas-turbine engine 12, 12′, the overall pressure ratio of the gas-turbine engine 12, 12′, and the expected range of rotational speeds thereof. Aerodynamic conditions vary over a greater range in the relatively-upstream (i.e. front) stages of the compressor 18, 18.1 than in the relatively-downstream (i.e. rear) stages, responsive to changes in rotational speed and load of the gas-turbine engine 12, 12′. Accordingly, the variable-stator-vane stages 16.1, 16.2, 16.3, 16.4, 16.5, 16.i, 16.j provide for adapting to the varying aerodynamic conditions associated therewith so as to provide for maintaining an optimal, or planned, level of performance of the gas-turbine engine 12, 12′ over the expected range of operating conditions. Furthermore, additional stator vanes 14, 14.2 may be oriented at fixed rotational angles α, αₐ, α_{b}, α_{c} for those stator-vane stages 24 for which the variation in aerodynamic conditions does not have a sufficiently substantial affect on the level of performance of the gas-turbine engine 12, 12′ over the expected range of operating conditions. Generally, the number of variable-stator-vane stages 16.1, 16.2, 16.3, 16.4, 16.5, 16.i, 16.j and the number of fixed-stator-vane stages 24 of the gas-turbine engine 12, 12′ will depend upon the cycle characteristics of the gas-turbine engine 12, 12′ and the operating range thereof, wherein the number of variable-stator-vane stages 16.1, 16.2, 16.3, 16.4, 16.5, 16.i, 16.j is at least two, and the number of fixed-stator-vane stages 24 is greater than or equal to zero.

Each of the variable stator vanes 14, 14.1 incorporates a stem shaft 48 that extends through the housing 50 of the gas-turbine engine 12, 12′ and that defines the rotational axis 26 about which the associated variable stator vane 14, 14.1 can rotate, and also defines the orientation of the associated variable stator vane 14, 14.1 within the gas-turbine engine 12, 12′. For each of the variable-stator-vane stages 16.1, 16.2, 16.3, 16.4, 16.5, 16.i, 16.j, each of the associated variable stator vanes 14, 14.1 is operatively coupled to a corresponding drive ring 54, 54.1, 54.2, 54.3, 54.4, 54.5, 54.i, 54.j with a corresponding associated lever arm 56, a first end portion 56.1 of which is fixedly coupled to the stem shaft 48, and a second end portion 56.2 of which is pivotally attached at to the corresponding drive ring 54, 54.1, 54.2, 54.3, 54.4, 54.5, 54.i, 54.j, so that a rotation 58 of a particular drive ring 54, 54.1, 54.2, 54.3, 54.4, 54.5, 54.i, 54.j about the rotational axis 60 of the gas-turbine engine 12, 12′ causes each of the associated lever arms 56 and the corresponding variable stator vanes 14, 14.1 associated therewith to both rotate about its corresponding rotational axis 26, thereby changing the rotational angles α of each of the variable stator vanes 14, 14.1 associated with that particular drive ring 54, 54.1, 54.2, 54.3, 54.4, 54.5, 54.i, 54.j. The rotational position of each drive ring 54, 54.1, 54.2, 54.3, 54.4, 54.5, 54.i, 54.j is controlled via a corresponding turnbuckle link 62 that operatively couples—for example, pivotally attaches via associated spherical rod ends 64 at each end of the turnbuckle link 62—the associated drive ring 54, 54.1, 54.2, 54.3, 54.4, 54.5, 54.i, 54.j to the variable-stator-vane actuation system 10, wherein, for example, a first end 62′ of each turnbuckle link 62 is pivotally attached to the associated drive ring 54, 54.1, 54.2, 54.3, 54.4, 54.5, 54.i, 54.j via an associated flange portion 66 operatively coupled to, or extending from, the corresponding associated drive ring 54, 54.1, 54.2, 54.3, 54.4, 54.5, 54.i, 54.j.

Referring to FIG. 1, the variable-stator-vane actuation system 10 comprises a plurality of couplers 68, 68.1, 68.2, 68.3, 68.4, 68.5, each of which is operatively coupled to a second end 62″ of a corresponding turnbuckle link 62, which together provide for positioning a corresponding associated drive ring 54, 54.1, 54.2, 54.3, 54.4, 54.5, 54.i, 54.j. The relative positions of the couplers 68, 68.1, 68.2, 68.3, 68.4, 68.5 relative to one another can be individually positioned by action of a plurality of associated rotational-positioning actuators 70, 70.1, 70.2, 70.3, 70.4. The plurality of couplers 68, 68.1, 68.2, 68.3, 68.4, 68.5 are operatively coupled to one another to form a coupler subassembly 72. For one set of embodiments, and for the embodiment illustrated in FIG. 1, a first (upstream-most) end 72.1 of the coupler subassembly 72 is operatively coupled to a linear actuator 74, and a second (downstream-most) end 72.2 of the coupler subassembly 72 is operatively coupled to a fixedly-located pivot 76. From the first (upstream-most) end 72.1 to the second (downstream-most) end 72.2 of the coupler subassembly 72, the corresponding associated couplers 68.1, 68.2, 68.3, 68.4, 68.5 are respectively coupled to corresponding drive rings 54.1, 54.2, 54.3, 54.4, 54.5 that are progressively further downstream from one another relative to the gas-turbine engine 12, 12′. In one set of embodiments, and for the embodiment illustrated in FIG. 1, for a particular motion by the linear actuator 74, the amount of the corresponding resulting change of position of the associated couplers 68, 68.1, 68.2, 68.3, 68.4, 68.5 is proportional to the distance of the coupler 68, 68.1, 68.2, 68.3, 68.4, 68.5 from the fixedly-located pivot 76, so as to provide for relatively upstream variable stator vanes 14, 14.1 to be rotated relatively more that relatively downstream variable stator vanes 14, 14.1 responsive to the action of the linear actuator 74,—consistent with a typical vane-control strategy for a multi-vane-stage gas-turbine engine 12, 12′—whereas the rotational-positioning actuators 70, 70.1, 70.2, 70.3, 70.4 provide for modifying—e.g. fine-tuning—the rotational positions of the variable stator vanes 14, 14.1 relative to those which result from action of the linear actuator 74 alone.

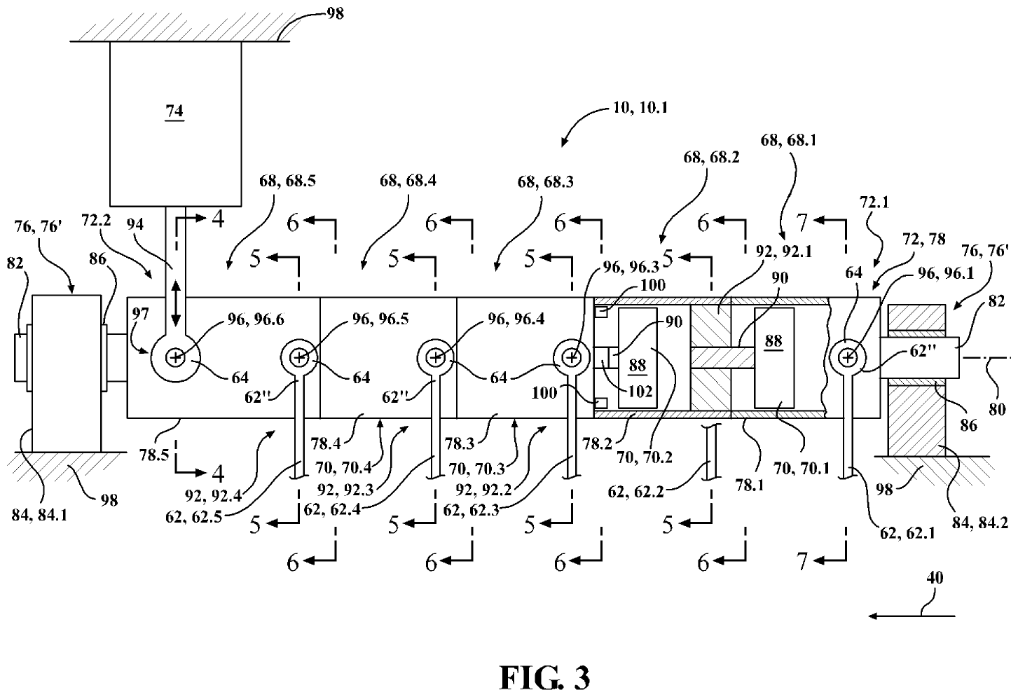

Referring to FIGS. 3-7, in accordance with a first aspect 10.1, the variable-stator-vane actuation system 10, 10.1 comprises a segmented, tubular-coupler subassembly 72, 78 incorporating a plurality of tubular-coupler segments 78.1, 78.2, 78.3, 78.4, 78.5—functioning as corresponding associated couplers 68, 68.1, 68.2, 68.3, 68.4, 68.5—that are operatively coupled to one another and that share a common rotational axis 80, wherein stub shafts 82 outwardly extending from the outermost ends of the upstream-most 78.1 and downstream-most 78.5 tubular-coupler segments are rotationally supported by respective bearing blocks 84, 84.1, 84.2 that are fixed relative to the gas-turbine engine 12, 12′ and that provide for rotation of the segmented, tubular-coupler subassembly 72, 78 about the rotational axis 80, thereby constituting a first aspect of the associated fixedly-located pivot 76, 76′. For example, in one set of embodiments, the stub shafts 82 are rotationally-supported by corresponding sleeve bearings 86 within the bearing blocks 84, 84.1, 84.2. Each of the tubular coupler segments 78.1, 78.2, 78.3, 78.4, 78.5 of the segmented, tubular-coupler subassembly 72, 78 are interconnected to an adjacent tubular-coupler segment 78.1, 78.2, 78.3, 78.4, 78.5 by a rotational-positioning actuator 70, 70.1, 70.2, 70.3, 70.4 acting therebetween, wherein a stator/housing 88 of the rotational-positioning actuator 70, 70.1, 70.2, 70.3, 70.4 is operatively coupled to the interior of one of the tubular-coupler segments 78.1, 78.2, 78.3, 78.4, 78.5, and a rotor shaft 90 of the rotational-positioning actuator 70, 70.1, 70.2, 70.3, 70.4 is operatively coupled via an associated disk 92 to the interior of an adjacent tubular-coupler segment 78.1, 78.2, 78.3, 78.4, 78.5.

As will be appreciated more fully herein below, and in contradistinction to the arrangement illustrated in FIG. 1, the linear actuator 74 is operatively coupled to the second (downstream-most) end 72.2 of the coupler subassembly 72 so as to more-readily provide for the range of rotational angles α to be greater for relatively upstream variable stator vanes 14, 14.1 than for relatively downstream variable stator vanes 14, 14.1.

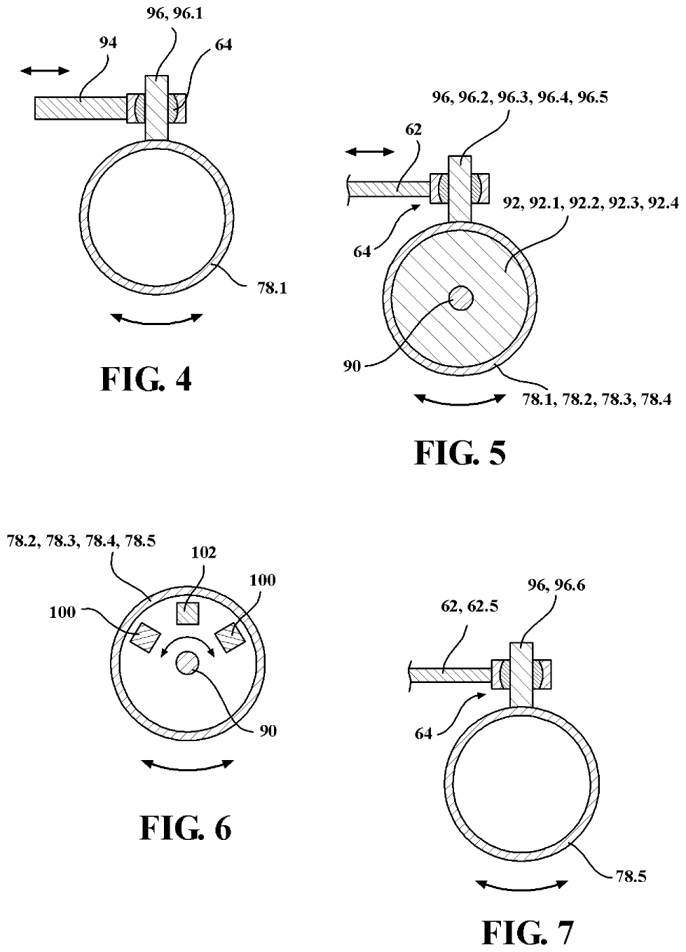

More particularly, referring to FIGS. 3 and 4, an actuator rod 94 of a linear actuator 74 is operatively coupled to the outside of a fifth (downstream-most) tubular-coupler segment 78.5, for example, via a spherical rod end 64 of the actuator rod 94 in cooperation with a sixth radially-oriented pin 96, 96.6 depending from the outside of a relatively downstream end portion the fifth (downstream-most) tubular-coupler segment 78.5 at an associated coupling location 97. The fifth (downstream-most) tubular-coupler segment 78.5 is also operatively coupled to a spherical rod end 64 of a second end 62″ of a fifth (downstream-most) turnbuckle link 62, 62.5, via a fifth radially-oriented pin 96, 96.5 depending from the outside of a relatively upstream end portion the fifth (downstream-most) tubular-coupler segment 78.5, wherein a first end 62′ of the fifth (downstream-most) turnbuckle link 62, 62.5 is operatively coupled to a corresponding fifth (downstream-most) drive ring 54, 54.5. Accordingly, with the housing of the linear actuator 74 coupled to mechanical ground 98 (i.e. to the housing 50 of the gas-turbine engine 12, 12′), a linear translation of the actuator rod 94 causes the fifth (downstream-most) tubular-coupler segment 78.5, and the fifth radially-oriented pin 96, 96.5 depending from the outside of a relatively upstream portion of the fifth (downstream-most) tubular-coupler segment 78.5, to rotate, which in turn causes a corresponding linear translation of the fifth (downstream-most) turnbuckle link 62, 62.5 and a corresponding resulting rotation of the fifth (downstream-most) drive ring 54, 54.5 of the corresponding fifth (upstream-most) variable-stator-vane stage 16.5.

Referring to FIGS. 3 and 5, a fourth tubular-coupler segment 78.4 is operatively coupled to the fifth (downstream-most) tubular-coupler segment 78.5 by a fourth rotational-positioning actuator 70, 70.4 via a corresponding fourth disk 92, 92.4 operatively coupled to the interior of the fifth (downstream-most) tubular-coupler segment 78.5 and operatively coupled to a rotor shaft 90 of the fourth rotational-positioning actuator 70, 70.4, with the stator/housing 88 of the fourth rotational-positioning actuator 70, 70.4 operatively coupled to the interior of the fourth tubular-coupler segment 78.4, wherein the fourth rotational-positioning actuator 70, 70.4 provides for controlling the relative rotational position of the fourth 78.4 and fifth 78.5 tubular-coupler segments relative to one another. Furthermore, the fourth tubular-coupler segment 78.4 is also operatively coupled to a spherical rod end 64 of a second end 62″ of a fourth turnbuckle link 62, 62.4, via a fourth radially-oriented pin 96, 96.4 depending from the outside of a relatively upstream end portion the fourth tubular-coupler segment 78.4, wherein a first end 62′ of the fourth turnbuckle link 62, 62.4 is operatively coupled to a corresponding fourth drive ring 54, 54.4 of the corresponding fourth variable-stator-vane stage 16.4.

A third tubular-coupler segment 78.3 is operatively coupled to the fourth tubular-coupler segment 78.4 by a third rotational-positioning actuator 70, 70.3 via a corresponding third disk 92, 92.3 operatively coupled to the interior of the fourth tubular-coupler segment 78.4 and operatively coupled to a rotor shaft 90 of the third rotational-positioning actuator 70, 70.3, with the stator/housing 88 of the third rotational-positioning actuator 70, 70.3 operatively coupled to the interior of the third tubular-coupler segment 78.3, wherein the third rotational-positioning actuator 70, 70.3 provides for controlling the relative rotational position of the third 78.3 and fourth 78.4 tubular-coupler segments relative to one another. Furthermore, the third tubular-coupler segment 78.3 is also operatively coupled to a spherical rod end 64 of a second end 62″ of a third turnbuckle link 62, 62.3, via a third radially-oriented pin 96, 96.3 depending from the outside of a relatively upstream end portion the third tubular-coupler segment 78.3, wherein a first end 62′ of the third turnbuckle link 62, 62.3 is operatively coupled to a corresponding third drive ring 54, 54.3 of the corresponding third variable-stator-vane stage 16.3.

A second tubular-coupler segment 78.2 is operatively coupled to the third tubular-coupler segment 78.3 by a second rotational-positioning actuator 70, 70.2 via a corresponding second disk 92, 92.2 operatively coupled to the interior of the third tubular-coupler segment 78.3 and operatively coupled to a rotor shaft 90 of the second rotational-positioning actuator 70, 70.2, with the stator/housing 88 of the second rotational-positioning actuator 70, 70.2 operatively coupled to the interior of the second tubular-coupler segment 78.2, wherein the second rotational-positioning actuator 70, 70.2 provides for controlling the relative rotational position of the second 78.2 and third 78.3 tubular-coupler segments relative to one another. Furthermore, the second tubular-coupler segment 78.2 is also operatively coupled to a spherical rod end 64 of a second end 62″ of a second turnbuckle link 62, 62.2, via a second radially-oriented pin 96, 96.2 depending from the outside of a relatively upstream end portion the second tubular-coupler segment 78.2, wherein a first end 62′ of the second turnbuckle link 62, 62.2 is operatively coupled to a corresponding second drive ring 54, 54.2 of the corresponding second variable-stator-vane stage 16.2

A first (upstream-most) tubular-coupler segment 78.1 is operatively coupled to the second tubular-coupler segment 78.2 by a first rotational-positioning actuator 70, 70.1 via a corresponding first disk 92, 92.1 operatively coupled to the interior of the second tubular-coupler segment 78.2 and operatively coupled to a rotor shaft 90 of the first rotational-positioning actuator 70, 70.1, with the stator/housing 88 of the first rotational-positioning actuator 70, 70.1 operatively coupled to the interior of the first tubular-coupler segment 78.1, wherein the first rotational-positioning actuator 70, 70.1 provides for controlling the relative rotational position of the first 78.1 and second 78.2 tubular-coupler segments relative to one another. Furthermore, referring to FIGS. 3 and 7, the first (upstream-most) tubular-coupler segment 78.5 is also operatively coupled to a spherical rod end 64 of a second end 62″ of a first (downstream-most) turnbuckle link 62, 62.1, via a first radially-oriented pin 96, 96.1 depending from the outside of a relatively upstream end portion the first (upstream-most) tubular-coupler segment 78.1, wherein a first end 62′ of the first (upstream-most) turnbuckle link 62, 62.1 is operatively coupled to a corresponding first (upstream-most) drive ring 54, 54.1 of the corresponding first (downstream-most) variable-stator-vane stage 16.1.

Referring to FIGS. 3 and 6, in one set of embodiments, the relative motion of each pair of adjacent tubular-coupler segments 78.1, 78.2, 78.3, 78.4, 78.5 is constrained by a pair of fixed stops 100 operatively coupled to a tubular-coupler segment 78.2, 78.3, 78.4, 78.5 containing a rotational-positioning actuator 70, 70.1, 70.2, 70.3, 70.4, that cooperate with a tang 102 depending from a corresponding disk 92, 92.1, 92.2, 92.3, 92.4 associated with an adjacent tubular-coupler segment 78.1, 78.2, 78.3, 78.4.

Accordingly, the translational position of the fifth (downstream-most) turnbuckle link 62, 62.5 is directly responsive to the translational position of the actuator rod 94 of the linear actuator 74; the translational position of the fourth turnbuckle link 62, 62.4 is responsive to both the translational position of the fifth (downstream-most) turnbuckle link 62, 62.5 and to the relative rotational position of the fourth rotational-positioning actuator 70, 70.4; the translational position of the third turnbuckle link 62, 62.3 is responsive to both the translational position of the fourth turnbuckle link 62, 62.4 and to the relative rotational position of the third rotational-positioning actuator 70, 70.3; the translational position of the second turnbuckle link 62, 62.2 is responsive to both the translational position of the third turnbuckle link 62, 62.3 and to the relative rotational position of the second rotational-positioning actuator 70, 70.2; and the translational position of the first (upstream-most) turnbuckle link 62, 62.1 is responsive to both the translational position of the second turnbuckle link 62, 62.2 and to the relative rotational position of the first rotational-positioning actuator 70, 70.1; thereby providing for the positions of each of the turnbuckle links 62, 62.1, 62.2, 62.3, 62.4, 62.5 to be individually set or fine-tuned, but for all of them to also be moved collectively responsive to the linear actuator 74. More particularly, the change in displacement ΔYᵢ of the i^{th} turnbuckle link 62, 62.1, 62.2, 62.3, 62.4, 62.5 is given by:

$$Δ {Y}_{i} = {R}_{T} \cdot ( \frac{Δ {Y}_{A}}{{R}_{A}} + {\sum }_{k = i}^{iMAX} Δ {β}_{( k : K + 1 )} ) \qquad ( 1 )$$

wherein R_{T} is the radial offset of the spherical rod ends 64 of the turnbuckle link 62, 62.1, 62.2, 62.3, 62.4, 62.5 relative to the rotational axis 80 of the segmented, tubular-coupler subassembly 72, 78, R_{A} is the radial offset of the spherical rod end 64 of the actuator rod 94 relative to the rotational axis 80 of the segmented, tubular-coupler subassembly 72, 78 (R_{A}=R_{T} in the embodiment illustrated in FIGS. 3-5 and 7), ΔY_{A} is the change in displacement of the actuator rod 94, iMAX is the maximum number of turnbuckle links 62, 62.1, 62.2, 62.3, 62.4, 62.5 (e.g. 5), Δβ_{(k,k+1)} is the change in relative angle of the (k)^{th} rotational-positioning actuator 70, 70.1, 70.2, 70.3, 70.4, wherein Δβ_{(iMAS,iMAX+1)}=0 and a positive angle Δβ_{(k,k+1)} causes a rotation of the (k+1)^{st} tubular-coupler segment 78.1, 78.2, 78.3, 78.4, 78.5 in the same rotational direction as a positive change in displacement of the actuator rod 94.

It should be understood that the relative locations of the rotational-positioning actuator 70, 70.1, 70.2, 70.3, 70.4 and disk 92, 92.1, 92.2, 92.3, 92.4 relative to the pairs of adjacent tubular-coupler segments 78.1, 78.2, 78.3, 78.4, 78.5 could be reversed for any or all pairs. Furthermore, it should also be understood that the linear actuator 74, actuator rod 94 and first radially-oriented pin 96, 96.1 could be replaced with a rotational-positioning actuator 70 operative with respect to mechanical ground 98 that would provide for rotationally positioning the first (upstream-most) tubular-coupler segment 78.1.

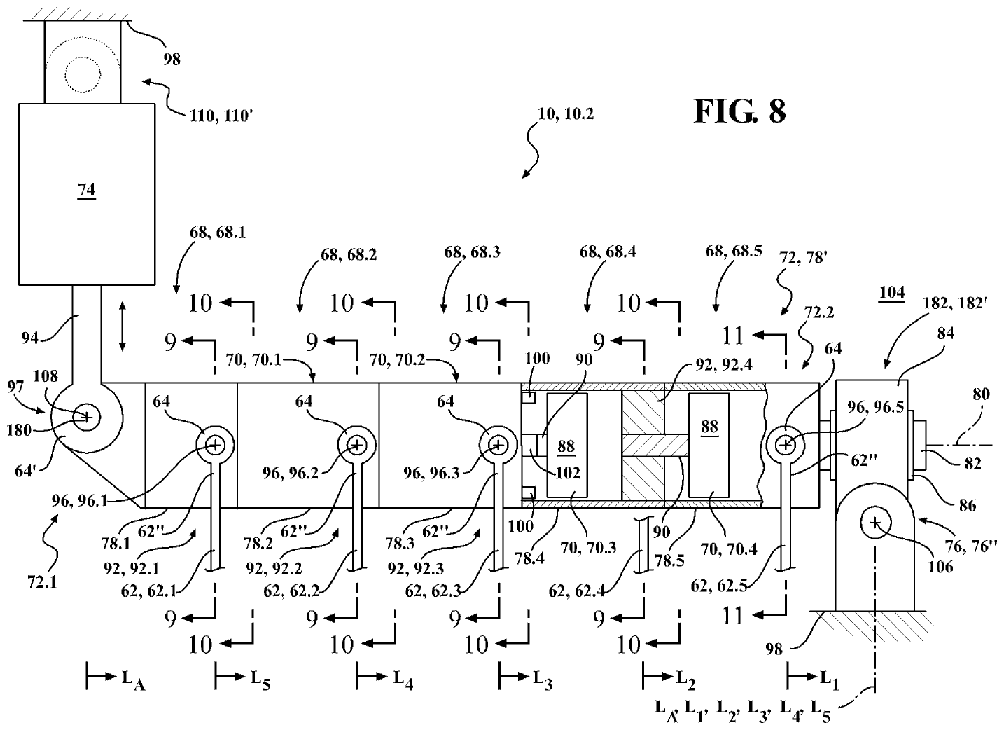

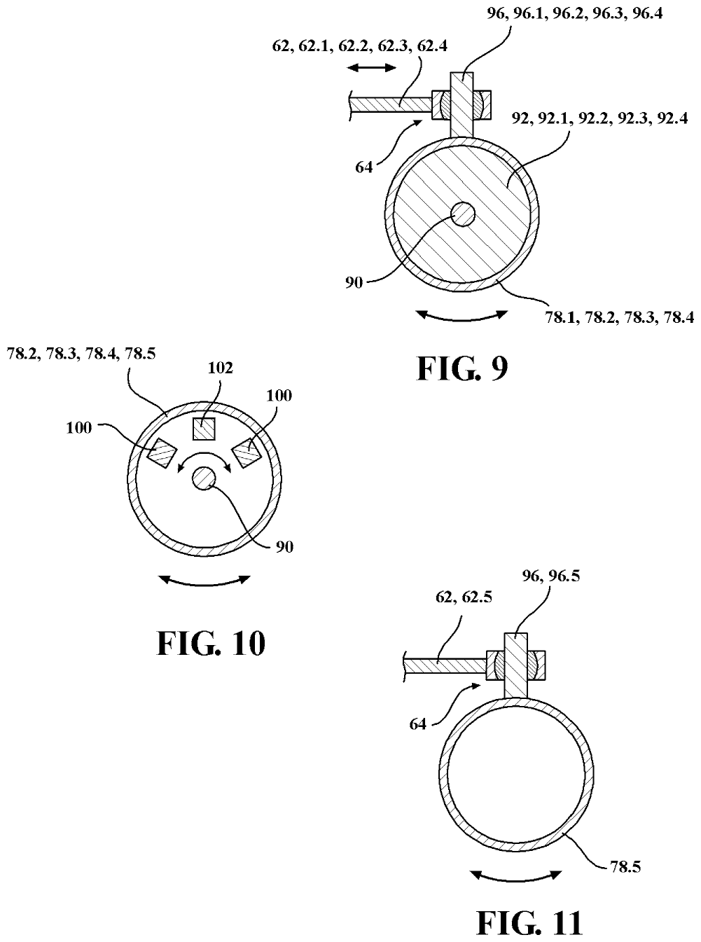

Referring to FIGS. 8-11, a second aspect 10.2 of a variable-stator-vane actuation system 10, 10.2 incorporates a segmented, tubular-coupler subassembly 72, 78′ that is similar to the above described segmented, tubular-coupler subassembly 72, 78 associated with the first aspect variable-stator-vane actuation system 10, 10.1 except for the operative coupling thereof to the linear actuator 74, and except for incorporating a second aspect of the associated fixedly-located pivot 76, 76″. More particularly, in accordance with the second aspect 10.2, the entire subassembly of the segmented, tubular-coupler subassembly 72, 78′ can be rotated in the plane 104 containing the associated first rotational axis 80 of the segmented, tubular-coupler subassembly 72, 78′ and substantially parallel to the associated turnbuckle links 62, 62.1, 62.2, 62.3, 62.4, 62.5 (i.e. the plane 104 of the illustration), about a second rotational axis 106—of the second-aspect fixedly-located pivot 76, 76″—that is normal to that plane 104. The second-aspect fixedly-located pivot 76, 76″ is operatively coupled to the second (downstream-most) end 72.2 of the segmented, tubular-coupler subassembly 72, 78′ via an associated bearing block 84 that provides for independent rotation of the segmented, tubular-coupler subassembly 72, 78′ about an associated first rotational axis 80. The first (upstream-most) end 72.1 of the segmented, tubular-coupler subassembly 72, 78′ is operatively coupled at an associated coupling location 97 to the actuator rod 94 of the linear actuator 74 via an associated spherical rod end or pin coupler 64′ that can rotate with respect to the segmented, tubular-coupler subassembly 72, 78′, about a third rotational axis 108, parallel to the second rotational axis 106. Actuation of the linear actuator 74 provides for rotating the segmented, tubular-coupler subassembly 72, 78′ about the second rotational axis 106, without rotation about the first rotational axis 80. As the segmented, tubular-coupler subassembly 72, 78′ is rotated, an associated change in the lateral distance between the second 106 and third 108 rotational axes is accommodated either by a provision for the associated stub shaft 82 to slide within the sleeve bearing 86 of the associated bearing block 84, or optionally by a provision for the linear actuator 74 to pivot with respect to mechanical ground 98 via an associated pivotal attachment 110 thereto, for example, via an associated clevis 110′.

In operation, actuation of the linear actuator 74—in either extension or retraction—causes a rotation of the segmented, tubular-coupler subassembly 72, 78′ about the second rotational axis 106, which causes a displacement of each of the turnbuckle links 62, 62.1, 62.2, 62.3, 62.4, 62.5, the magnitude of which displacement progressively decreases with increasing distance in a downstream direction as a result of segmented, tubular-coupler subassembly 72, 78′ acting as a lever pivoted about the second rotational axis 106, which naturally provides for accommodating the greater variability of aerodynamic conditions at relatively upstream locations, relative to relatively downstream locations, of the variable-stator-vane stages 16.1, 16.2, 16.3, 16.4, 16.5. In cooperation with these lever-related displacements of the turnbuckle links 62, 62.1, 62.2, 62.3, 62.4, 62.5 responsive to actuation of the linear actuator 74, the associated relative displacements of the turnbuckle links 62, 62.1, 62.2, 62.3, 62.4, 62.5 can each be modified, or fine-tuned, by adjustment of the associated rotational-positioning actuators 70, 70.1, 70.2, 70.3, 70.4, wherein the change in displacement ΔYᵢ of the i^{th} turnbuckle link 62, 62.1, 62.2, 62.3, 62.4, 62.5 is given by:

$$Δ {Y}_{i} = Δ {Y}_{A} \cdot \frac{{L}_{i}}{{L}_{A}} + {R}_{T} \cdot {\sum }_{k = 1}^{i} Δ {β}_{( k : - 1 : k )} \qquad ( 2 )$$

wherein, the nomenclature is the same as for equation (1), and L_{A} and Lᵢ, respectively, are the respective distances from the second rotational axis 106 to the spherical rod end or pin coupler 64′ of the actuator rod 94, and to the spherical rod end 64 of the of the i^{th} turnbuckle link 62, 62.1, 62.2, 62.3, 62.4, 62.5.

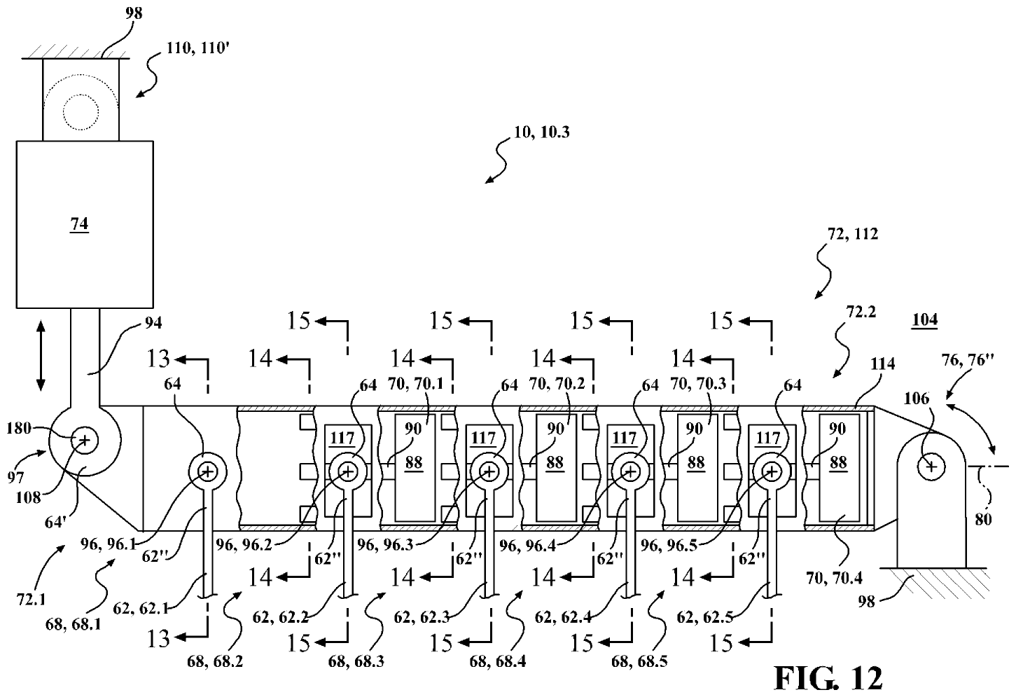

Referring to FIGS. 12-15, a third aspect 10.3 of a variable-stator-vane actuation system 10, 10.3 incorporates a tubular-coupler subassembly 72, 112 incorporating a tubular frame 114—with an internal first rotational axis 80—that is pivoted about a second rotational axis 106 of an associated second-aspect fixedly-located pivot 76, 76″ at a second (downstream-most) end 72.2 of the tubular-coupler subassembly 72, 112, wherein the second rotational axis 106 is normal to the plane 104 containing the associated first rotational axis 80 and substantially perpendicular to the associated turnbuckle links 62, 62.1, 62.2, 62.3, 62.4, 62.5. The first (upstream-most) end 72.1 is operatively coupled at an associated coupling location 97 to the actuator rod 94 of the linear actuator 74 via an associated spherical rod end or pin coupler 64′ that can rotate with respect to the segmented, tubular-coupler subassembly 72, 112 about a third rotational axis 108 parallel to the second rotational axis 106. Actuation of the linear actuator 74 provides for rotating the tubular-coupler subassembly 72, 112 about the second rotational axis 106, without rotation about the first rotational axis 80. As the tubular-coupler subassembly 72, 112 is rotated, an associated change in the lateral distance between the second 106 and third 108 rotational axes is accommodated by a provision for the linear actuator 74 to pivot with respect to mechanical ground 98 via an associated pivotal attachment 110 thereto, for example, via an associated clevis 110′.

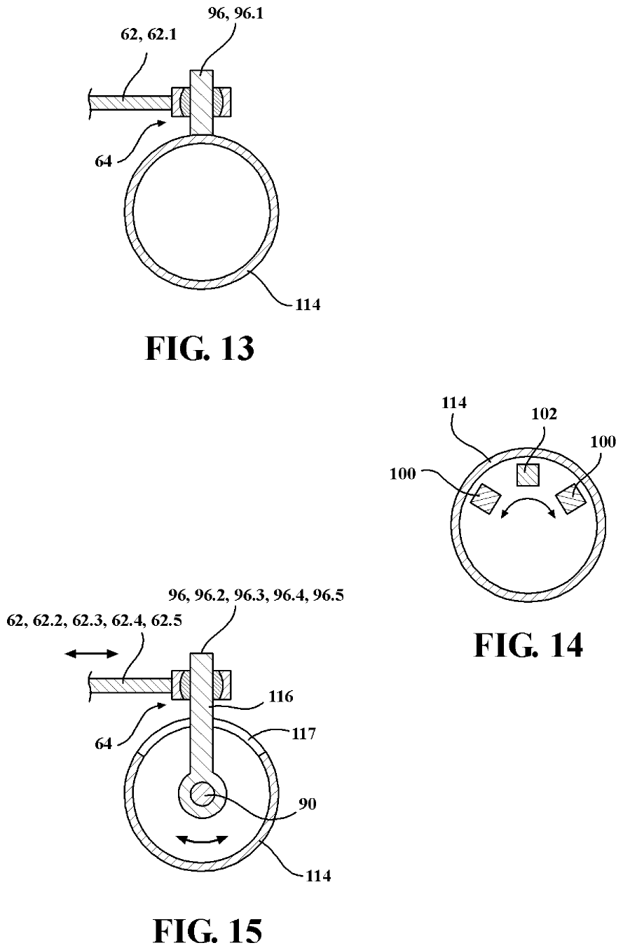

Referring to FIGS. 12 and 13, a spherical rod end 64 of a second end 62″ of a first (upstream-most) turnbuckle link 62, 62.1 is operatively coupled to a first radially-oriented pin 96, 96.1 depending from the outside of a relatively upstream end portion of the tubular frame 114, wherein a first end 62′ of the first (upstream-most) turnbuckle link 62, 62.1 is also operatively coupled to a corresponding first (upstream-most) drive ring 54, 54.1 Accordingly, with the housing of the linear actuator 74 operatively coupled to mechanical ground 98 (i.e. to the housing 50 of the gas-turbine engine 12, 12′) via the pivotal attachment 110, 110′, a linear translation of the actuator rod 94 causes the tubular frame 114, and the first radially-oriented pin 96, 96.1 depending therefrom to translate, which in turn causes a corresponding linear translation of the first (upstream-most) turnbuckle link 62, 62.1 and a corresponding resulting rotation of the first (upstream-most) drive ring 54, 54.1 of the corresponding first (upstream-most) variable-stator-vane stage 16.1.

Referring to FIGS. 12 and 15, a spherical rod end 64 of a second end 62″ of each of the second 62.2 through fifth 62.5 turnbuckle links 62, 62.2, 62.3, 62.4, 62.5 is operatively coupled to a corresponding radially-oriented pin 96, 96.2, 96.3, 96.4, 96.5 depending from a corresponding arm 116 that is operatively coupled to a rotor shaft 90 of a corresponding associated rotational-positioning actuator 70, 70.1, 70.2, 70.3, 70.4, the stators/housings 88 of which are each operatively coupled to the interior of the tubular frame 114. Each of the arms 116 extends outward from the tubular frame 114 through a corresponding slot 117 therein, wherein the actuated radially-oriented pins 96, 96.2, 96.3, 96.4, 96.5 function as corresponding associated couplers 68, 68.1, 68.2, 68.3, 68.4, 68.5.

Referring to FIGS. 12 and 14, in one set of embodiments, the relative motion of each arm 116, relative to tubular frame 114, is constrained by a pair of fixed stops 100 operatively coupled to the interior of the tubular frame 114 that cooperate with a tang 102 depending from a corresponding arm 116 associated with a particular turnbuckle link 62, 62.2, 62.3, 62.4, 62.5, so as to provide for limiting the associated displacement thereof relative to the tubular frame 114.

The linear actuator 74 provides for rotating the tubular frame 114 about the second rotational axis 106 of the fixedly-located pivot 76″, which in turn causes each radially-oriented pin 96, 96.1, 96.2, 96.3, 96.4, 96.5 and associated turnbuckle link 62, 62.1, 62.2, 62.3, 62.4, 62.5 operatively coupled thereto to be displaced by an amount proportional to the corresponding distance from the second rotational axis 106, and proportional to the displacement of the actuator rod 94 of the linear actuator 74. Furthermore, each of the second 62.2 through fifth 62.5 turnbuckle links 62, 62.2, 62.3, 62.4, 62.5 can be independently positioned relative to the tubular frame 114 by rotation of the corresponding associated rotational-positioning actuator 70, 70.1, 70.2, 70.3, 70.4, subject to rotational limits imposed by the associated fixed stops 100. Accordingly, the change in displacement ΔYᵢ of the i^{th} turnbuckle link 62, 62.1, 62.2, 62.3, 62.4, 62.5 is given by:

$$Δ {Y}_{i} = Δ {Y}_{A} \cdot \frac{{L}_{i}}{{L}_{A}} + {R}_{T} \cdot Δ {β}_{i} \qquad ( 3 )$$

wherein, the nomenclature is the same as for equations (1) and (2), and Δβᵢ is the change in angle of the i^{th} rotational-positioning actuator 70, 70.1, 70.2, 70.3, 70.4, wherein Δβᵢ=0 and a positive angle Δβᵢ causes a displacement of the i^{th} radially-oriented pin 96, 96.2, 96.3, 96.4, 96.5 in the same direction as a positive change in displacement of the actuator rod 94.

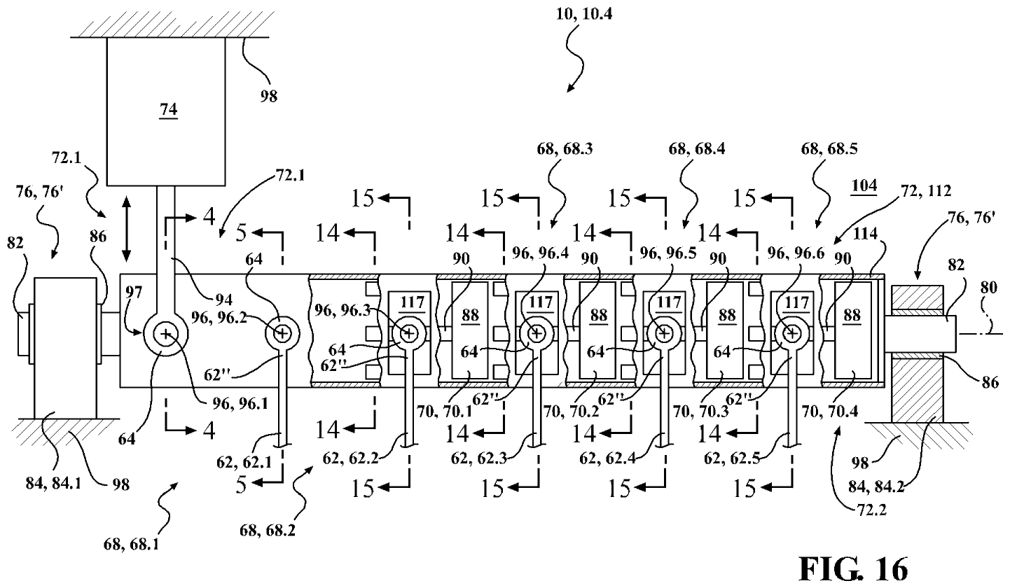

Referring to FIG. 16, a fourth aspect 10.4 of a variable-stator-vane actuation system 10, 10.4 comprises a hybrid of the above-described first 10.1 and third 10.3 aspects of the variable-stator-vane actuation system 10, 10.1, 10.3, incorporating the tubular-coupler subassembly 72, 112 in accordance with the third-aspect variable-stator actuation system 10, 10.3 in cooperation with—in accordance with the first-aspect variable-stator actuation system 10, 10.1—the linear actuator 74, the associated coupling of the spherical rod end 64 of the actuator rod 94 to a first radially-oriented pin 96, 96.1 depending from the outside of a relatively downstream end portion the tubular frame 114 of the tubular-coupler subassembly 72, 112 at the associated coupling location 97, and with stub shafts 82 extending from the ends of the tubular-coupler subassembly 72, 112 that cooperate with associated sleeve bearings 86 of associated first-aspect fixedly-located pivots 76, 76′ located upstream and downstream of the tubular-coupler subassembly 72, 112 that provide for rotation of the tubular-coupler subassembly 72, 112 about the associated rotational axis 80 defined by the first-aspect fixedly-located pivots 76, 76′. The operative coupling of the turnbuckle links 62, 62.1, 62.2, 62.3, 62.4, 62.5 to the tubular-coupler subassembly 72, 112 is the same as for the third-aspect variable-stator actuation system 10, 10.3.

Accordingly, the translational position of the first (upstream-most) turnbuckle link 62, 62.1 is directly responsive to the translational position of the actuator rod 94 of the linear actuator 74, and the translational positions of the remaining turnbuckle links 62, 62.2, 62.3, 62.4, 62.5—which can each be independently positioned relative to the tubular frame 114 by rotation of the corresponding associated rotational-positioning actuator 70, 70.1, 70.2, 70.3, 70.4—is responsive to both the translational position of the actuator rod 94 of the linear actuator 74, and to the rotational position of the associated rotational-positioning actuator 70, 70.1, 70.2, 70.3, 70.4. More particularly, the change in displacement ΔYᵢ of the i^{th} turnbuckle link 62, 62.1, 62.2, 62.3, 62.4, 62.5 is given by:

$$Δ {Y}_{i} = {R}_{T} \cdot ( \frac{Δ {Y}_{A}}{{R}_{A}} + Δ {β}_{i} ) \qquad ( 4 )$$

wherein R_{T}, R_{A} and, ΔY_{A} are defined the same as for equation (1), and Δβᵢ is defined the same as for equation (3).

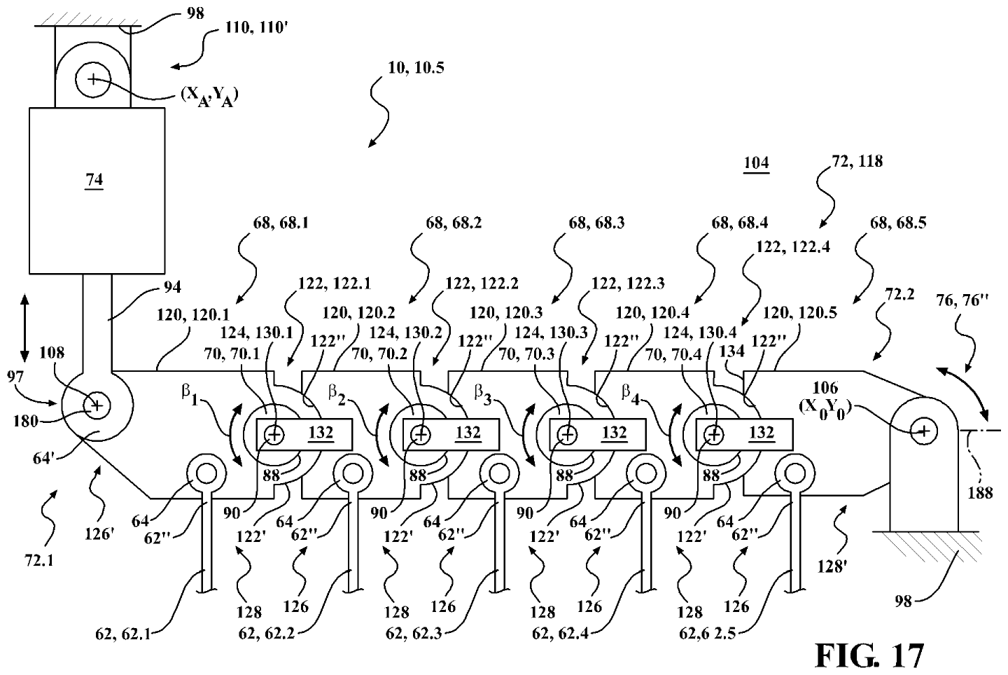

Referring to FIG. 17, a fifth aspect 10.5 of a variable-stator-vane actuation system 10, 10.5 incorporates an associated coupler subassembly 72, 118, wherein a first (upstream-most) end 72.1 thereof is operatively coupled at the associated coupling location 97 to an actuator rod 94 of a linear actuator 74 and a second (downstream-most) end 72.2 thereof is operatively coupled to a second-aspect fixedly-located pivot 76″, similar to the above-described third aspect variable-stator-vane actuation system 10, 10.3 illustrated in FIGS. 12-15. The associated linear actuator 74 is also similarly operatively coupled to mechanical ground 98 via a pivotal attachment 110, 110′ to provide for adapting to changes in the horizontal separation of the rotational axis 108 of the actuator rod 94 attachment from the rotational axis 106 of the fixedly-located pivot 76″, responsive to actuation of the linear actuator 74.

The coupler subassembly 72, 118 incorporates a plurality of coupler links 120, 120.1, 120.2, 120.3, 120.4, 120.5 that function as corresponding associated couplers 68, 68.1, 68.2, 68.3, 68.4, 68.5. Each coupler link 120 of the plurality mates with an adjacent coupler link 120 of the plurality, at a joint 122 comprising a convex circular profile 122′ on an end of one of the coupler link 120 and a corresponding concave circular profile 122″ on an opposing end of the adjacent coupler link 120, wherein each pair of adjacent coupler links 120 can rotate with respect to one another about a corresponding center of rotation 124 at the center of the convex 122′ and concave 122″ circular profiles. An upstream-most end 126′ of a first coupler link 120.1 is operatively coupled to a spherical rod end or pin coupler 64′ of the actuator rod 94, and the downstream-most end 128 of the first coupler link 120.1 incorporates the convex circular profile 122′ associated with a first joint 122.1. The particular coupler subassembly 72, 118 illustrated in FIG. 17 further incorporates second 120.2, third 120.3, fourth 120.4 and fifth 120.5 coupler links—although, most generally, the number of coupler links 120 is not limiting other than there being at least two—the upstream-most ends 126 of each of which incorporate the above-described concave circular profile 122″ associated with corresponding first 122.1, second 122.2, third 122.3 and fourth 122.4 joints. The downstream-most ends 128 of the second 120.2, third 120.3 and fourth 120.4 coupler links incorporate the above-described convex circular profile 122′ associated with the corresponding second 122.2, third 122.3 and fourth 122.4 joints. Each of the joints 122.1, 122.2. 122.3, 122.4 provides for rotation about a corresponding axis of rotation 130.1, 130.2, 130.3, 130.4 that is coincident with the corresponding centers of rotation 124 thereof, and parallel to the respective rotational axes 106, 108 of the second-aspect fixedly-located pivot 76″ and of the actuator rod 94 attachment, respectively. The downstream-most end 128′ of the fifth coupler link 120.5 is adapted to pivot about the rotational axis 106 of the second-aspect fixedly-located pivot 76″.

It should be understood that, alternatively, the relative locations of the convex 122′ and concave 122″ circular profiles, relative to the associated coupler links 120.1, 120.2, 120.3, 120.4, 120.5 could be reversed.

Each of the joints 122.1, 122.2. 122.3, 122.4 of the coupler subassembly 72, 118 incorporates a corresponding rotational-positioning actuator 70, 70.1, 70.2, 70.3, 70.4, a stator/housing 88 portion of which is operatively coupled to the portion of the coupler link 120.1, 120.2, 120.3, 120.4 of the joint 122.1, 122.2. 122.3, 122.4 having the associated convex circular profile 122′—centered about the associated center of rotation 124 of the joint 122.1, 122.2. 122.3, 122.4—a rotor shaft 90 portion of which is operatively coupled to an arm 132 depending from the portion of the coupler link 120.2, 120.3, 120.4, 120.5 proximate to the associated concave circular profile 122″, wherein the rotational-positioning actuators 70, 70.1, 70.2, 70.3, 70.4 provide for controlling the relative angles β1, β2, β3, β4 of the associated joints 122.1, 122.2. 122.3, 122.4 between the coupler links 120.1, 120.2, 120.3, 120.4, 120.5, about the corresponding axes of rotation 130.1, 130.2, 130.3, 130.4.

Each of the coupler links 120.1, 120.2, 120.3, 120.4, 120.5 incorporates a set of stops 134 associated with each of the convex 122′ and concave 122′ profiles that provide for limiting the rotational displacement—in either rotational direction—of the associated joints 122.1, 122.2, 122.3, 122.4.

The first coupler link 120.1 is operatively coupled to a spherical rod end 64 of a second end 62″ of a of a first (upstream-most) turnbuckle link 62, 62.1 at a location between the center of rotation 124 of the first joint 122.1 and the center of rotation of the spherical rod end or pin coupler 64′ of the actuator rod 94, wherein a first end 62′ of the first (upstream-most) turnbuckle link 62, 62.1 is operatively coupled to a corresponding first (upstream-most) drive ring 54, 54.1. The second coupler link 120.2 is operatively coupled to a spherical rod end 64 of a second end 62″ of a second turnbuckle link 62, 62.2 at a location between the centers of rotation 124 of the first 122.1 and second 122.2 joints, wherein a first end 62′ of the second turnbuckle link 62, 62.2 is operatively coupled to a corresponding second drive ring 54, 54.2 of the corresponding second variable-stator-vane stage 16.2. The third coupler link 120.3 is operatively coupled to a spherical rod end 64 of a second end 62″ of a third turnbuckle link 62, 62.3 at a location between the centers of rotation 124 of the second 122.2 and third 122.3 joints, wherein a first end 62′ of the third turnbuckle link 62, 62.3 is operatively coupled to a corresponding third drive ring 54, 54.3 of the corresponding third variable-stator-vane stage 16.3. The fourth coupler link 120.4 is operatively coupled to a spherical rod end 64 of a second end 62″ of a fourth turnbuckle link 62, 62.4 at a location between the centers of rotation 124 of the third 122.3 and fourth 122.4 joints, wherein a first end 62′ of the fourth turnbuckle link 62, 62.4 is operatively coupled to a corresponding fourth drive ring 54, 54.4 of the corresponding fourth variable-stator-vane stage 16.4. The fifth (downstream-most) coupler link 120.5 is operatively coupled to a spherical rod end 64 of a second end 62″ of a fifth (downstream-most) turnbuckle link 62, 62.5 at a location between the center of rotation 124 of the fourth joint 122.4 and the rotational axis 106 of the second-aspect fixedly-located pivot 76″, wherein a first end 62′ of the fifth (downstream-most) turnbuckle link 62, 62.5 is operatively coupled to a corresponding fifth (downstream-most) drive ring 54, 54.5 of the corresponding fifth (downstream-most) variable-stator-vane stage 16.5.

The translational displacements of each of the turnbuckle links 62, 62.1, 62.2, 62.3, 62.4, 62.5 is responsive to a linear displacement of the actuator rod 94 of the linear actuator 74 (the same as for the second 10.2 and third 10.3 aspects of the variable-stator-vane actuation system 10, 10.2, 10.3). Furthermore, a rotational displacement of any of the rotational-positioning actuators 70, 70.1, 70.2, 70.3, 70.4, individually or collectively, will also cause a corresponding translational displacements of each of the turnbuckle links 62, 62.1, 62.2, 62.3, 62.4, 62.5, which complicates a general solution for the relationship of the linear displacements of each of the turnbuckle links 62, 62.1, 62.2, 62.3, 62.4, 62.5 responsive to combination of a linear displacement of the actuator rod 94 and rotational displacements of the rotational-positioning actuators 70, 70.1, 70.2, 70.3, 70.4.

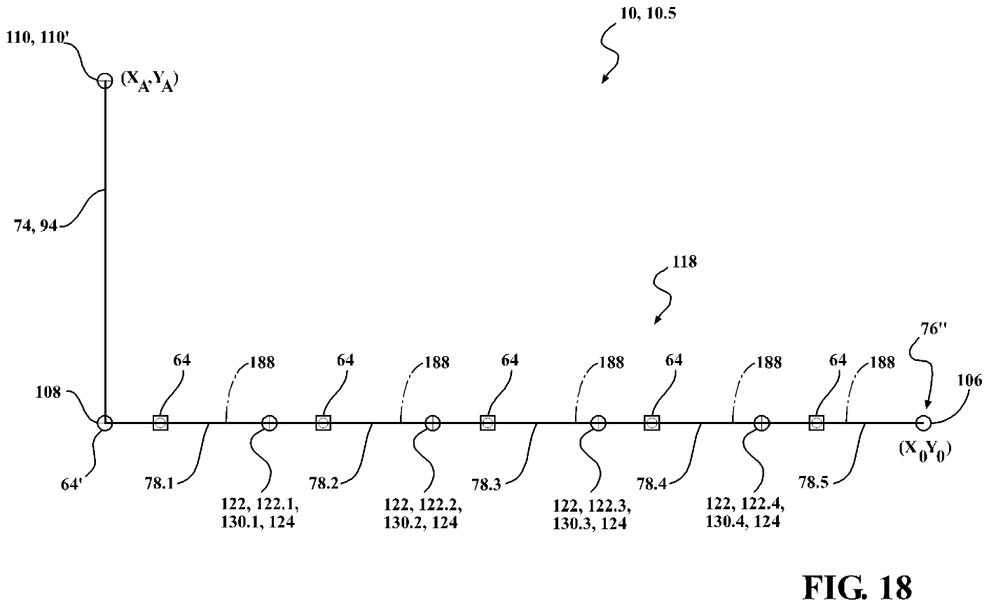

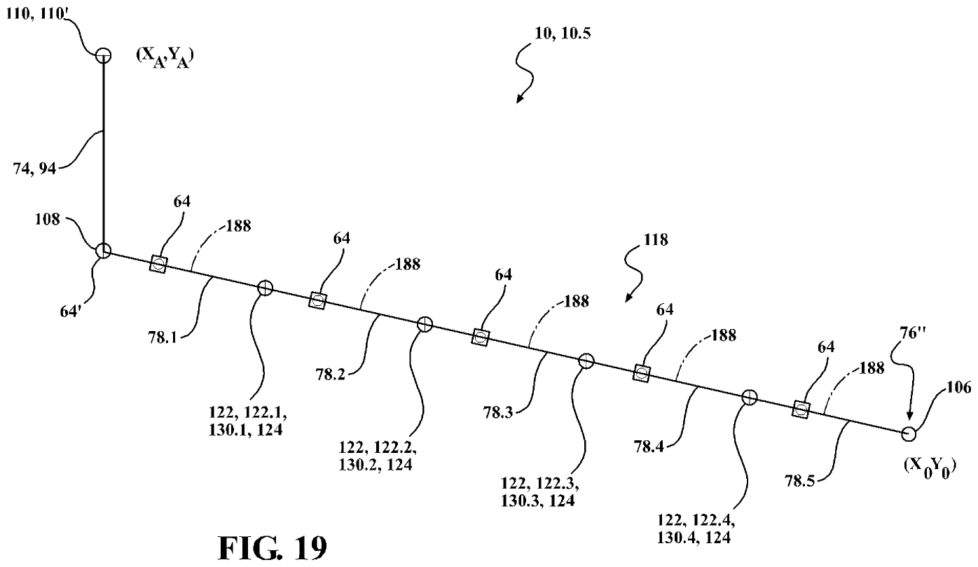

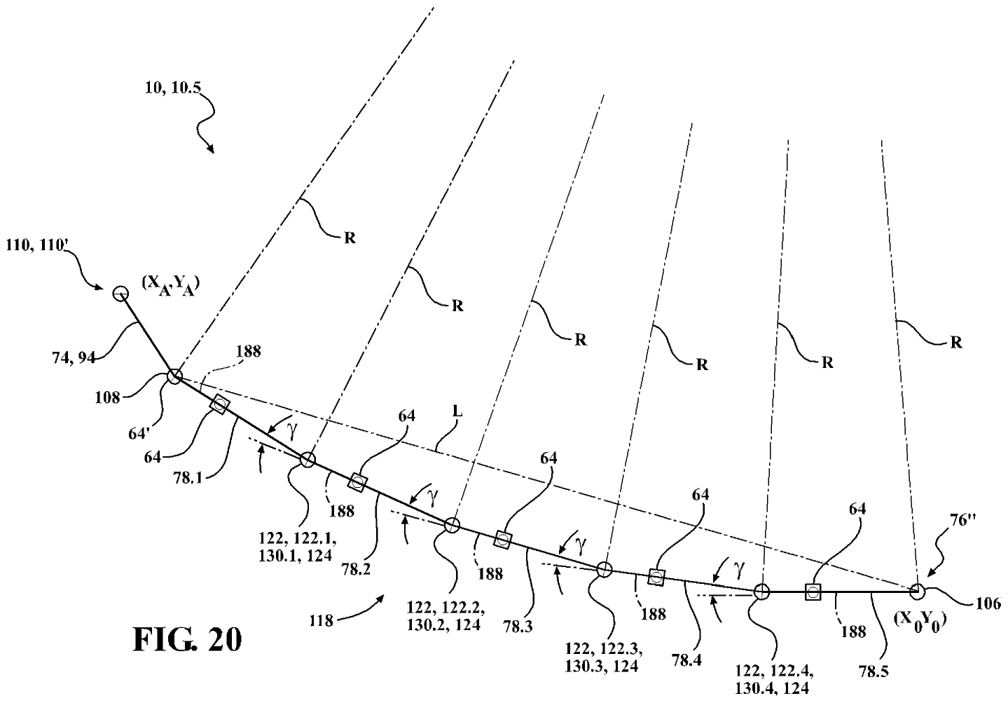

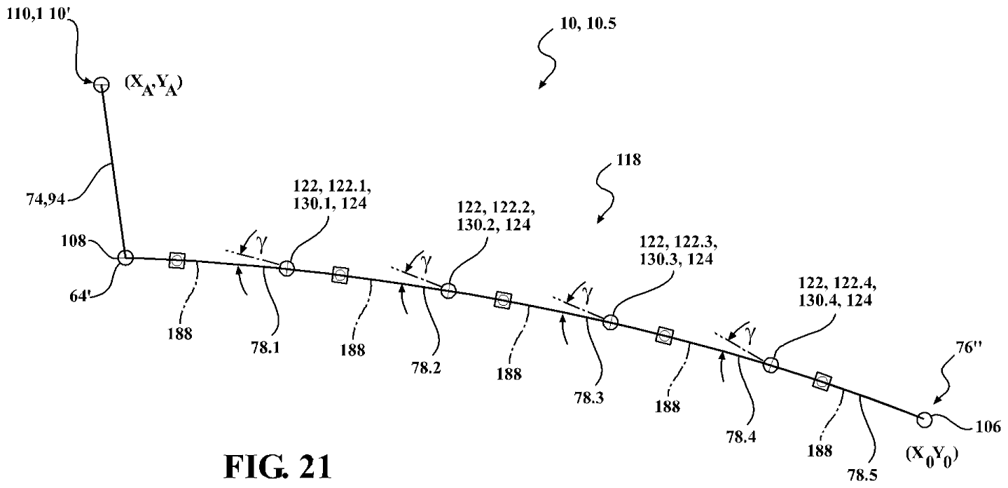

Referring to FIGS. 18-22, in accordance with one mode of operation of the fifth-aspect variable-stator-vane actuation system 10, 10.5, each of the relative angles β1, β2, β3, β4 of the coupler links 120.1, 120.2, 120.3, 120.4, 120.5 is set by the rotational-positioning actuators 70, 70.1, 70.2, 70.3, 70.4 to a uniform magnitude relative angle γ, which provides for adjusting the shape of the relationship between turnbuckle displacement and relative downstream location, for which the relative displacements of the turnbuckle links 62, 62.1, 62.2, 62.3, 62.4, 62.5 can be readily calculated as a function of both the displacement of the actuator rod 94 of the linear actuator 74 and the uniform magnitude relative angle γ. In each of the configurations illustrated in FIGS. 18-22, the locations of the spherical rod end 64 connections to the turnbuckle links 62, 62.1, 62.2, 62.3, 62.4, 62.5 are assumed to be in line with each of the corresponding adjacent centers selected from the associated centers of rotation 124 of the joints 122, 122.1, 122.2. 122.3, 122.4, the rotational axis 106 of the second-aspect fixedly-located pivot 76″, and the center of the spherical rod end or pin coupler 64′ attachment to the actuator rod 94. Referring to FIG. 18, with the uniform magnitude relative angle γ of each pair of adjacent coupler links 120.1, 120.2, 120.3, 120.4, 120.5 set to zero, and with zero displacement of the actuator rod 94, each of the coupler links 120.1, 120.2, 120.3, 120.4, 120.5 and associated connections to the turnbuckle links 62, 62.1, 62.2, 62.3, 62.4, 62.5 are illustrated along a horizontal line associated with zero displacement of the turnbuckle links 62, 62.1, 62.2, 62.3, 62.4, 62.5. Referring to FIG. 19, with the same uniform magnitude relative angle γ=0 condition as illustrated in FIG. 18 except for a positive displacement of the actuator rod 94, the line of turnbuckle links 62, 62.1, 62.2, 62.3, 62.4, 62.5 is rotated in a positive direction, for which the magnitude of the associated displacements of the turnbuckle links 62, 62.1, 62.2, 62.3, 62.4, 62.5 is linearly proportional to the distance of each turnbuckle link 62, 62.1, 62.2, 62.3, 62.4, 62.5 from the rotational axis 106 of the second-aspect fixedly-located pivot 76″. Referring to FIG. 20, with the same condition as illustrated in FIG. 19 except with each rotational-positioning actuator 70, 70.1, 70.2, 70.3, 70.4 positioned at a positive uniform magnitude relative angle γ, the displacements of the turnbuckle links 62, 62.1, 62.2, 62.3, 62.4, 62.5 are relatively greater for relatively upstream turnbuckle links 62, 62.1, 62.2, 62.3, 62.4, 62.5 than for relatively downstream turnbuckle links 62, 62.1, 62.2, 62.3, 62.4, 62.5, relative to the linear condition illustrated in FIG. 19, the comparison of which is illustrated in FIG. 22. Referring to FIG. 21, with the same condition as illustrated in FIG. 19 except with each rotational-positioning actuator 70, 70.1, 70.2, 70.3, 70.4 positioned at a negative uniform magnitude relative angle γ, the displacements of the turnbuckle links 62, 62.1, 62.2, 62.3, 62.4, 62.5 are relatively lower for relatively upstream turnbuckle links 62, 62.1, 62.2, 62.3, 62.4, 62.5 than for relatively downstream turnbuckle links 62, 62.1, 62.2, 62.3, 62.4, 62.5, relative to the linear condition illustrated in FIG. 19, the comparison of which is illustrated in FIG. 22.

Referring again to FIG. 20, the displacements of the turnbuckle links 62, 62.1, 62.2, 62.3, 62.4, 62.5 can be calculated from the illustrated, simplified geometry—wherein each of the coupler links 120.1, 120.2, 120.3, 120.4, 120.5 acts as a facet of an associated polygon—based upon the known locations of the second-aspect fixedly-located pivot 76″ (X₀, Y₀) and the pivotal attachment 110 of the linear actuator 74 to the mechanical ground 98 (X_{A}, Y_{A}), the length of the linear actuator 74, the length of each coupler link 120.1, 120.2, 120.3, 120.4, 120.5, and the magnitude of the uniform relative angle γ, which provides for determining the radius R of the polygon, the direct length L of the coupler subassembly 72, 118, the locations of the centers of rotation 124 of the joints 122.1, 122.2. 122.3, 122.4, and from that, the locations of the spherical rod end 64 attachments of the turnbuckle links 62, 62.1, 62.2, 62.3, 62.4, 62.5 to the coupler links 120.1, 120.2, 120.3, 120.4, 120.5.

Any of the rotational-positioning actuators 70, 70.1, 70.2, 70.3, 70.4 can be embodied with any of a variety of means, for example, an electric motor, with or without gearing, with or without feedback—for example, in one set of embodiments, a stepper motor. Alternatively, any of the rotational-positioning actuators 70, 70.1, 70.2, 70.3, 70.4 could be embodied as a hydraulically-powered or pneumatically-powered (i.e. fluid-powered) motor or rotary positioner. Further alternatively, any of the rotational-positioning actuators 70, 70.1, 70.2, 70.3, 70.4 could be embodied with an electric-powered, fluid-powered, or cam-actuated-mechanical linear actuator or linear positioner in cooperation with a linear-to-rotary conversion mechanism. Similarly, the linear actuator 74 could be either electrically-powered, pneumatically-powered, or hydraulically-powered—for example as a motor driven rotary-to-linear conversion mechanism, for example, a ball-screw mechanism; or a fluid cylinder, i.e. a hydraulic cylinder or a pneumatic cylinder,—or embodied as a cam-actuated mechanical actuator.

Notwithstanding that the first 10.1 through fourth 10.4 aspects of the variable-stator actuation system 10.1, 10.2, 10.3, 10.4 have been illustrated with associated tubular-coupler subassemblies 72, 78, 78′, 112 and associated tubular-coupler segments 78.1, 78.2, 78.3, 78.4, 78.5, it should be understood that the associated structural elements need not necessarily be tubular per-se provided that the associated structure provides sufficient structural support for remaining elements—for example, the rotational positioning actuators 70, 70.1, 70.2, 70.3, 70.4, radially-oriented pins 96, 96.1, 96.2, 96.3, 96.4, 96.5, 96.6, and disks 92, 92.1, 92.2, 92.3, 92.4—to function as described hereinabove for the tubular configurations.

Furthermore, it should be understood that for any of the first 10.1, second 10.2 or fifth 10.5 aspects of the variable-stator actuation system 10.1, 10.2, 10.5, the associated turnbuckle links 62, 62.1, 62.2, 62.3, 62.4, 62.5 or actuator rod 94 could be attached to the coupler segments 78.1, 78.2, 78.3, 78.4, 78.5—for example, via the associated spherical rod ends 64 or spherical rod end or pin coupler 64′—anywhere along the length of the associated coupler segments 78.1, 78.2, 78.3, 78.4, 78.5 or coupler links 120.1, 120.2, 120.3, 120.4, 120.5; or coincident with that associated axes of rotation 130.1, 130.2, 130.3, 130.4 of the associated joints 122, 122.1, 122.2. 122.3, 122.4 of the fifth aspect variable-stator actuation system 10.5.

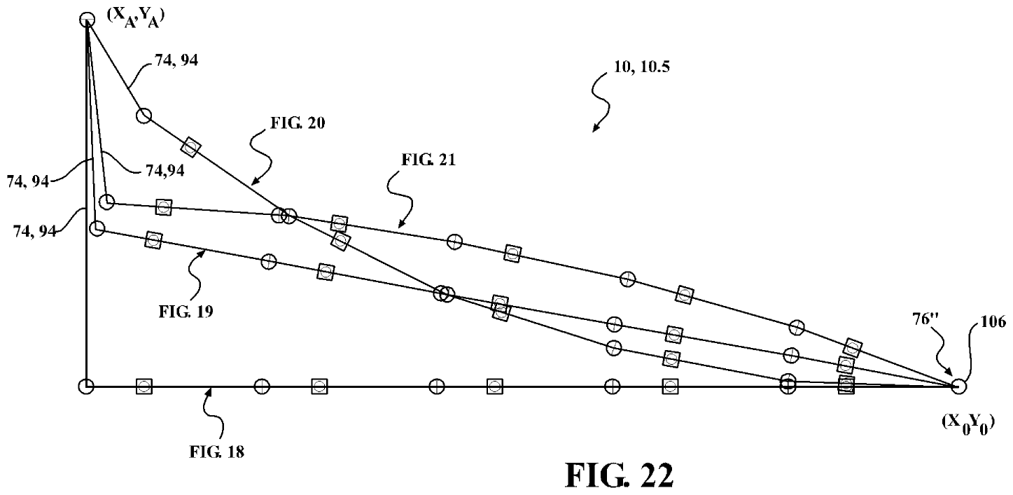

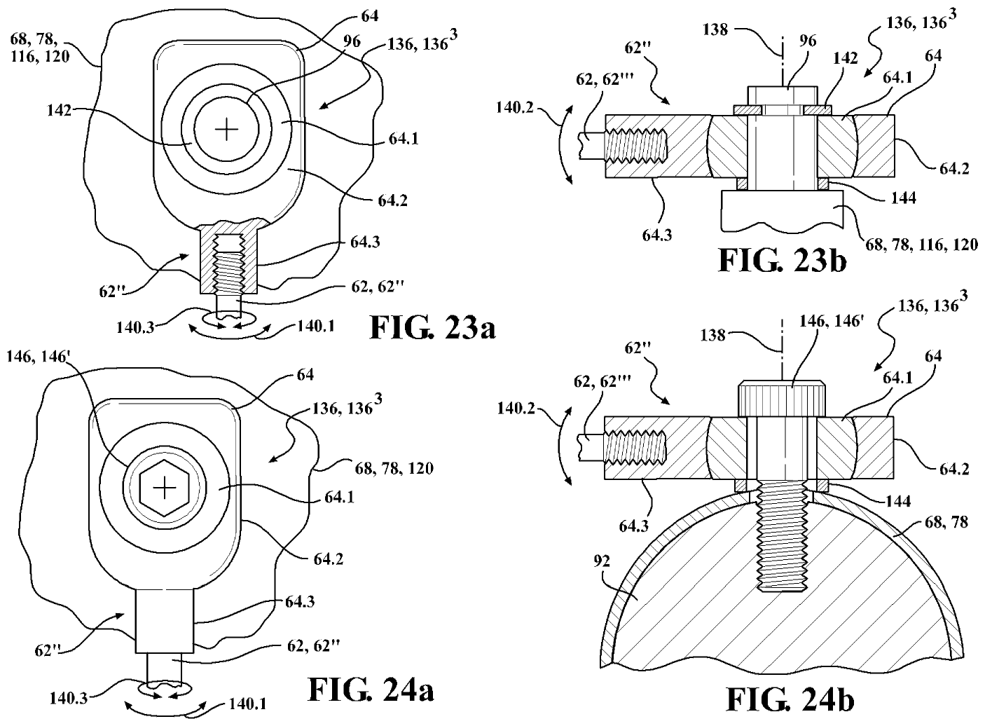

Referring to FIGS. 23a through 26b, the second ends 62″ of the turnbuckle links 62 can be connected to the associated couplers 68 by various means, each of which generally provides for an associated joint 136 having one or more rotational degrees-of-freedom so as to provide for associated rotation of the corresponding turnbuckle link 62 responsive to relative changes in positions of the first 62′ and second 62″ ends thereof either along or transverse to the direction of the rotational axis 60 of the gas-turbine engine 12, 12′. For example, in accordance with the above-illustrated first 10.1 through fifth 10.5 aspects of the variable-stator actuation system 10.1, 10.2, 10.3, 10.4, 10.5, the relative changes in positions of the first 62′ and second 62″ ends of the associated turnbuckle link 62 may result in a rotation either generally about the rotational axis 60 of the gas-turbine engine 12, or generally about an axis that is transverse thereto, depending upon the particular configuration. For example, referring to FIGS. 23a and 23b, a first embodiment of a spherical rod end 64 of an associated turnbuckle link 62 is coupled to an associated radially-oriented pin 96 either integral with, or depending from, the associated coupler 68—i.e. either integral with, or depending from, the tubular-coupler segments 78 of the first 10.1 or second 10.2 aspects of the variable-stator actuation system 10, 10.1, 10.2; the arm 116 of the third 10.3 or fourth 10.4 aspects of the variable-stator actuation system 10, 10.3, 10.4; or the coupler links 120 coupler links 120 of the fifth aspect 10.5 of the variable-stator-vane actuation system 10, 10.5,—wherein the radially-oriented pin 96 extends through a hole in associated truncated ball portion 64.1 of the spherical rod end 64, that mates with a surrounding socket portion 64.2 that is operatively coupled to a shaft portion 62′″ of the turnbuckle link 62, for example, with an end of the shaft portion 62′″ threaded into a necked portion 64.3 that depends from the socket portion 64.2. The spherical rod end 64 provides for a three-rotational-degree-of-freedom joint 136³ with two primary rotational degrees-of-freedom relative to the radial axis 138 of the radially-oriented pin 96: azimuthal rotation 140.1 about the radial axis 138, and elevational rotation 140.2 about an axis that is normal to the radial axis 138, and a radial rotation 140.3 about the axis of the turnbuckle link 62, wherein the ranges of elevational 140.2 and radial 140.3 rotations are limited by the construction and installation of the spherical rod end 64. The truncated ball portion 64.1 is retained on the radially-oriented pin 96 with a circlip or snap-ring 142, and possibly spaced away from the surface of the coupler 68 with a spacer 144 to provide for an increased range of elevational travel. Referring to FIGS. 24a and 24b, as an alternative to the radially-oriented pin 96 either integral with, or depending from, the associated coupler 68, the spherical rod end 64 could be attached to the coupler 68 with a threaded fastener 146, for example, a bolt 146′, that extends through the hole in the truncated ball portion 64.1 of the spherical rod end 64 and threads into the coupler 68, for example, into an associated disk 92 of the first 10.1 or second 10.2 aspects of the variable-stator actuation system 10, 10.1, 10.2.

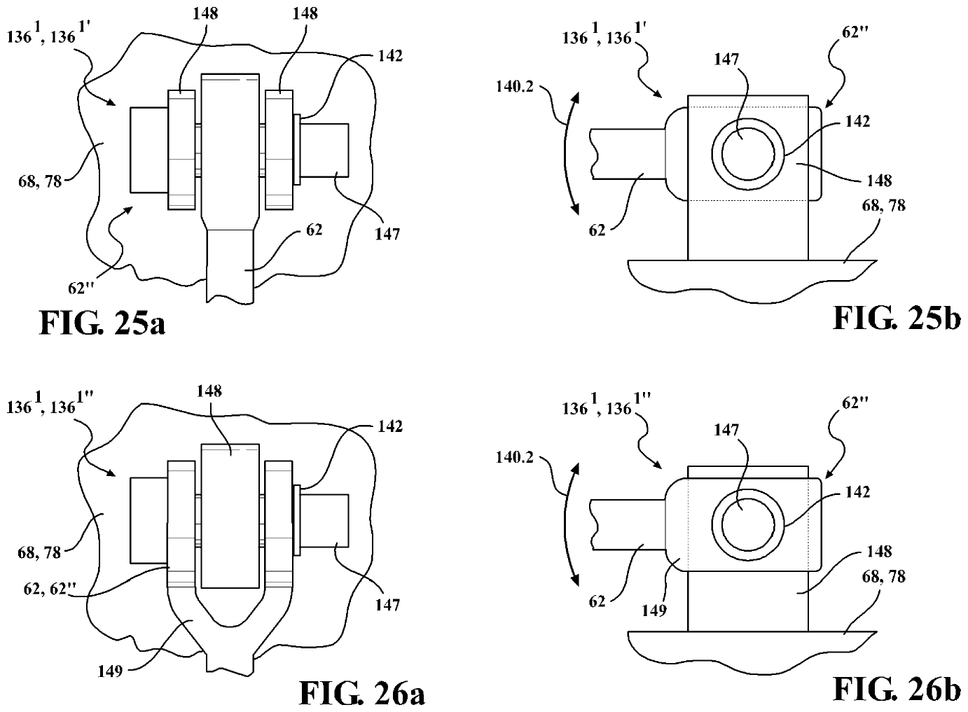

In accordance with the first 10.1 or fourth 10.4 aspects of the variable-stator actuation system 10, 10.1, 10.4, a one-rotational-degree-of-freedom joint 136′—providing for elevational rotation 140.2—would be sufficient to accommodate the effects of the rotation of the associated coupler subassembly 72 during operation thereof. For example, referring to FIGS. 25a and 25b, in accordance with a first embodiment of a one-rotational-degree-of-freedom joint 136″, the second end 62″ of the turnbuckle link 62 is pivoted about a pin 147 that extends through the second end 62″ of the turnbuckle link 62 and through a pair of tabs 148 that depend from the coupler 68 and that straddle the second end 62″ of the turnbuckle link 62. Alternatively, referring to FIGS. 26a and 26b, in accordance with a second embodiment of a one-rotational-degree-of-freedom joint 136¹″, the second end 62″ of the turnbuckle link 62 is terminated with a clevis 149 that is pivoted about a pin 147 that extends through a single tab 148 depending from the coupler 68.

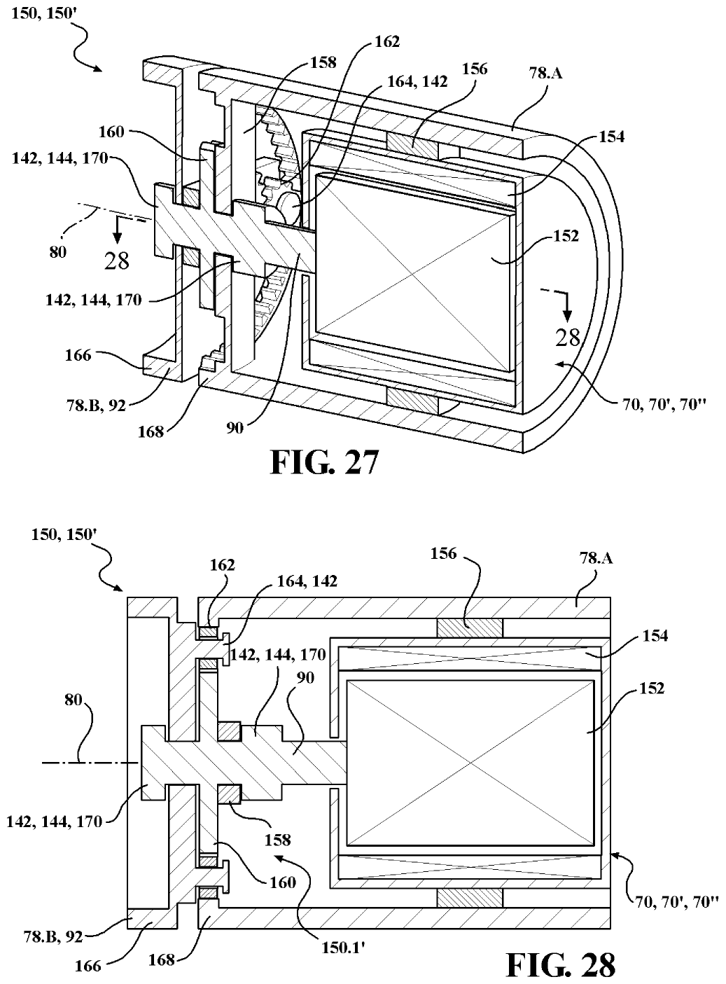

Referring to FIGS. 27-31, one or more of the rotational-positioning actuators 70, 70.1, 70.2, 70.3, 70.4 of the coupler subassembly 72 may be augmented with an associated gear train 150 to magnify the torque applied by the associated rotational-positioning actuator 70, 70.1, 70.2, 70.3, 70.4.

For example, referring to FIGS. 27 and 28, in accordance with application to either the first 10.1 or second 10.2 aspects of the variable-stator actuation system 10.1, 10.2, in one set of embodiments, the rotational-positioning actuator 70 is implemented as an electric motor 70′, for example, a stepper motor 70″, comprising a rotor portion 152 that is rotated responsive to, and with respect to, a stator portion 154, the latter of which is operatively coupled—for example, via a plurality of internal bosses or spacers 156 therebetween—to the inside of a first tubular-coupler segment 78.A, wherein the rotor portion 152 is operatively coupled through a planetary gear train 150′ to an adjacent second tubular-coupler segment 78.B, and the rotational axis of the rotor portion 152 is colinear with the rotational axis 80 of the coupler subassembly 72. The planetary gear train 150′ is configured so that the torque applied to the second tubular-coupler segment 78.B is greater than the torque applied by the rotational-positioning actuator 70, 70′, 70″ to the input 150.1′ of the planetary gear train 150′. The rotor shaft 90 of the electric motor 70, 70′, 70″ axially extends through, and is rotationally supported by, a strut 158 extending across the inside of the first tubular-coupler segment 78.A. The rotor shaft 90 is operatively coupled to a sun gear 160, 150.1′ of the planetary gear train 150′, which engages with a plurality of equi-angularly distributed planet gears 162—for example, two planet gears 162,—each of which rotates about a corresponding associated stem shaft 164 that depends from an associated carrier 166, wherein the planet gears 162 engage with, and are located between both the sun gear 160, 150.1′ and a ring gear 168. The planetary gear train 150′/coupler subassembly 72 incorporates a means for maintaining the elements of the planetary gear train 150′—i.e. the sun gear 160, planet gears 162, carrier 166, and ring gear 168,—and the first 78.A and second 78.B tubular-coupler segments in cooperation with one another, for example, collars 170, or circlip or snap-ring 142, possibly in cooperation with one or more associated spacers 144, secured to the rotor shaft 90 on the motor-side of the strut 158 and at the end of the rotor shaft 90, thereby spanning both the strut 158 depending from the first tubular-coupler segment 78.A, and the planetary gear train 150′, with the planet gears 162 also similarly retained on the associated stem shafts 164 with associated circlips or snap-rings 142. With the ring gear 168 of the planetary gear train 150′ fixed to the first tubular-coupler segment 78.A, a rotation of N_{A} revolutions of the sun gear 160, 150.1′ results in a rotation of N_{B}=N_{A}·S/(R+S) revolutions of the carrier 166—and of the second tubular-coupler segment 78.B,—wherein S and R are the number of teeth of the sun 16 and ring 168 gears, respectively. Accordingly, the torque T_{B} applied to the carrier 166—and to the second tubular-coupler segment 78.B—is magnified by a factor of (R+S)/S relative to the torque TA applied by the electric motor 70, 70′, 70″ to the sun gear 160, 150.1′.

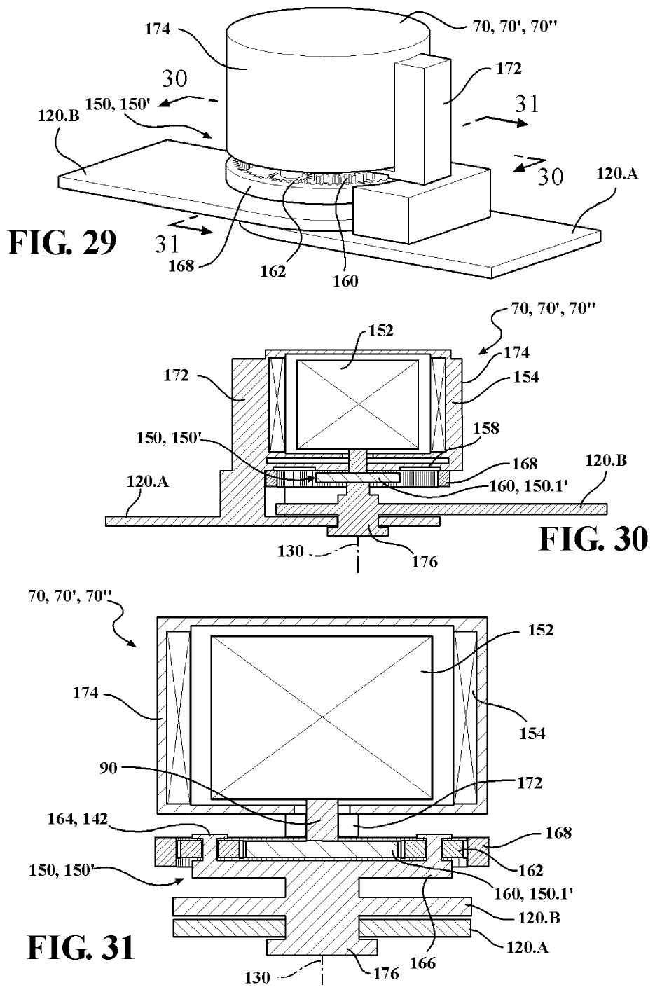

As another example, referring to FIGS. 29-31, in accordance with application to the fifth aspect 10.5 of the variable-stator actuation system 10.5, in one set of embodiments, the rotational-positioning actuator 70 is implemented as an electric motor 70′, for example, a stepper motor 70″, comprising a rotor portion 152 that is rotated responsive to, and with respect to, a stator portion 154, the latter of which is operatively coupled to a first coupler link 120.A—for example, via an associated post 172 depending transversely therefrom,—wherein the rotor portion 152 is operatively coupled through a planetary gear train 150′ to an adjacent second coupler link 120.B. The planetary gear train 150′ is configured so that the torque applied to the second coupler link 120.B is greater than the torque applied by the rotational-positioning actuator 70, 70′, 70″ to the input 150.1′ of the planetary gear train 150′. The rotor shaft 90 of the electric motor 70, 70′, 70″ axially extends through, and is rotationally supported by, a strut 158 extending across the housing 174 of the electric motor 70, 70′, 70″, and is operatively coupled to a sun gear 160, 150.1′ of the planetary gear train 150′, which engages with a plurality of equi-angularly distributed planet gears 162—for example, two planet gears 162,—each of which rotates about a corresponding associated stem shaft 164 that depends from an associated carrier 166, wherein the planet gears 162 engage with, and are located between both the sun gear 160, 150.1′ and a ring gear 168, and the strut 158 also couples the ring gear 168 to the housing 174 of the electric motor 70, 70′, 70″. The rotational axis of the rotor portion 152 of the electric motor 70, 70′, 70″ is colinear with the rotational axis 130 of the associated joint 122 between the first 120.A and second 120.B coupler links. The planetary gear train 150′/coupler subassembly 72 incorporates a means for maintaining the elements of the planetary gear train 150′—i.e. the sun gear 160, planet gears 162, carrier 166, and ring gear 168,—and the first 120.A and second 120.B coupler link in cooperation with one another, for example, by coupling the housing 174 of the electric motor 70, 70′, 70″ to the first coupler link 120.A, with the second coupler link 120.B sandwiched therebetween, with the carrier 166 fixedly coupled to the second coupler link 120.B and pivotally coupled to the first coupler link 120.A via an associated shaft extension 176, and with the planet gears 162 retained on the associated stem shaft 164 with associated circlips or snap-rings 142. With the ring gear 168 of the planetary gear train 150′ fixed to the first coupler link 120.A, a rotation of N_{A} revolutions of the sun gear 160, 150.1′ results in a rotation of N_{B}=N_{A}·S/(R+S) revolutions of the carrier 166—and of the second coupler link 120.B,—wherein S and R are the number of teeth of the sun 16 and ring 168 gears, respectively. Accordingly, the torque T_{B} applied to the carrier 166—and to the second coupler link 120.B—is magnified by a factor of (R+S)/S relative to the torque TA applied by the electric motor 70′, 70″ to the sun gear 160, 150.1′.

Referring to FIGS. 1, 8, 12 and 17, in accordance with the second 10.2, third 10.3, and fifth 10.5 aspects of the variable-stator actuation system 10, 10.2, 10.3, 10.5, and in the embodiment illustrated in FIG. 1, the coupler subassembly 72, 78′, 112, 118 acts as a lever pivoted about the second rotational axis 106 of the associated second-aspect fixedly-located pivot 76, 76″, wherein the length of the associated lever is the distance from the second rotational axis 106 to the third rotational axis 108 about which the coupling to the actuator rod 94 of the linear actuator 74 is centered. The projected length of the lever, i.e. the projected length of the coupler subassembly 72, 78′, 112, 118, projected on a line that is normal to a nominal line of action 178 of the actuator rod 94 of the linear actuator 74—for example, in the embodiment illustrated in FIG. 1, projected on the rotational axis 60 of the gas-turbine engine 12, 12′—will vary with the rotational angle of the lever—i.e. the coupler subassembly 72, 78′, 112, 118—about the second rotational axis 106, and for the fifth-aspect variable-stator actuation system 10, 10.2, will vary with the rotational angles of the associated rotational-positioning actuators 70, 70.1, 70.2, 70.3, 70.4.

In accordance with one set of embodiments, the variation of the projected length of the coupler subassembly 72, 78′, 112, 118 is accommodated by a pivotal attachment 110, 110′ that provides for the line of action 178 of the linear actuator 74 to change with changes of the axially-projected position of the third rotational axis 108, as illustrated in FIGS. 1, 8, 12 and 17-22 for the second 10.2, third 10.3, and fifth 10.5 aspects, respectively.

Alternatively, as illustrated in FIG. 1, the linear actuator 74 may be fixedly coupled to ground—i.e. without an associated pivotal attachment 110, 110′,—so that the line of action 178 of the actuator rod 94 of the linear actuator 74 is fixed, with either the coupler subassembly 72, 78′, 112, 118 or its associated attachments to either the actuator rod 94 or the second-aspect fixedly-located pivot 76, 76″ incorporating a joint that provides the length between the second 106 and third 108 rotational axes to change as necessary to provide for a substantially constant projected length thereof along a line that is perpendicular to the line of action 178 of the actuator rod 94. For example, in accordance with one set of embodiments, either the coupler subassembly 72, 78′, 112, 118 or the actuator rod 94 may incorporate a slot within which an associated pin 180 can slide, wherein the pin 180 provides for coupling the actuator rod 94 to the coupler subassembly 72, 78′, 112, 118 along the third rotational axis 108.

Furthermore, referring to FIG. 8, in accordance with the a variation of the second-aspect variable-stator actuation system 10, 10.2, the rotational coupling of the stub shaft 82 to the sleeve bearing 86 could be configured to provide for the stub shaft 82 to slide within the sleeve bearing 86. Alternatively, one or more pairs of associated tubular-coupler segments 78.1, 78.2, 78.3, 78.4, 78.5 could be configured to slide relative to one another, for example, with the associated rotor shaft(s) 90 splined to the corresponding disk(s) 92, 92.1, 92.2, 92.3, 92.4. Referring to FIGS. 12 and 17, in accordance with the variations of the third 10.3 and fifth 10.5 aspects of the variable-stator actuation system 10, 10.3, 10.5, the associated second-aspect fixedly-located pivot 76, 76″ could be configured similar to that of the second-aspect variable-stator actuation system 10, 10.2 illustrated in FIG. 8, for example, with a prismatic slideable joint provided for by a corresponding prismatic stub shaft (counterpart to stub shaft 82) and associated prismatic sleeve bearing (counterpart to sleeve bearing 86), for example, each having a cross-sectional profile, e.g. square or rectangular) that would constrain against axial rotation.

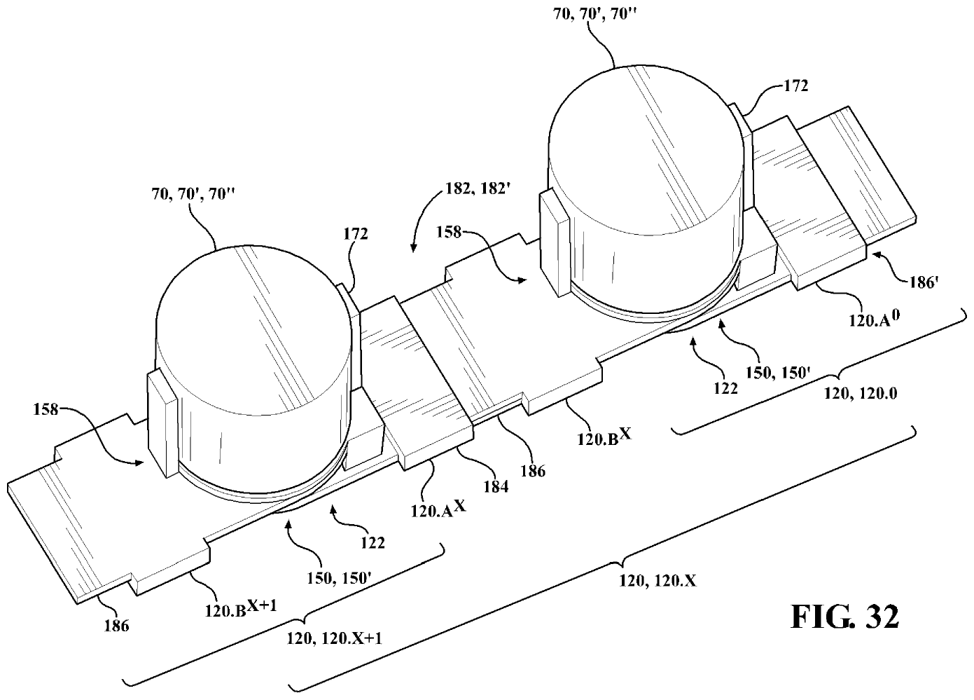

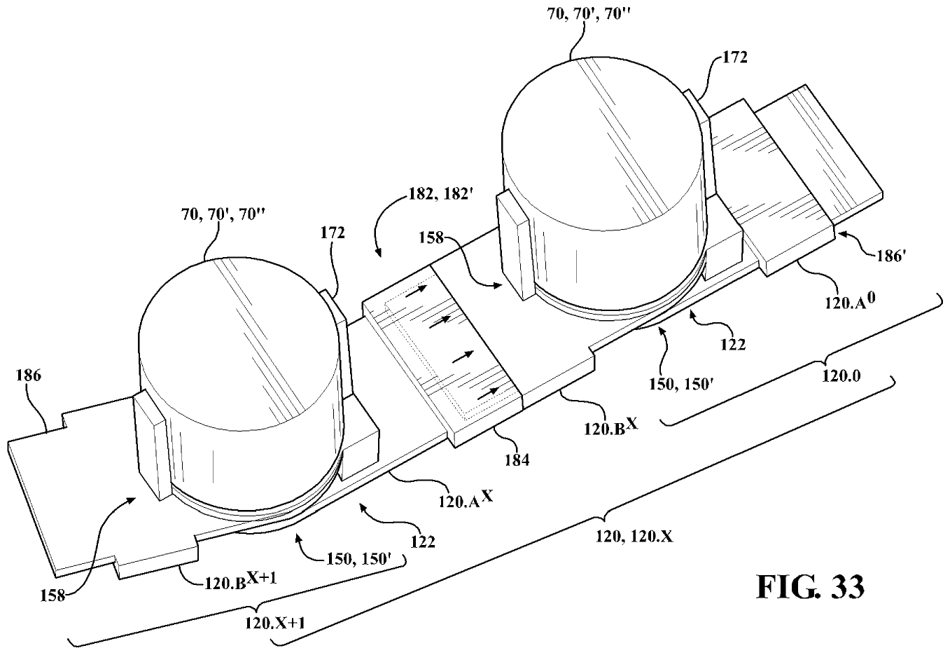

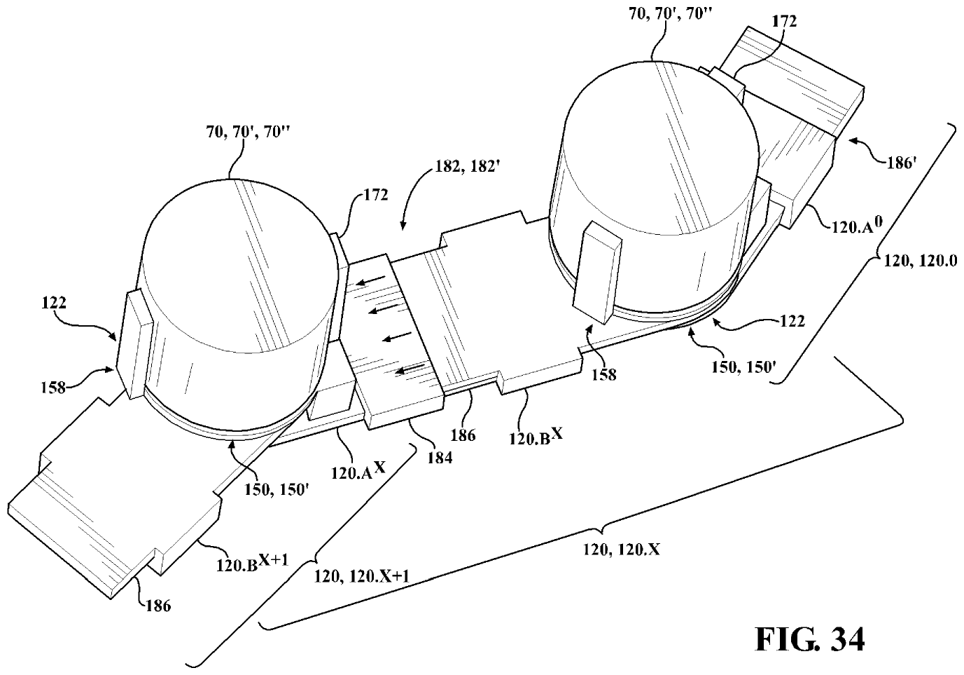

Yet further, referring to FIGS. 32-34, in respect of a variation of the fifth-aspect variable-stator actuation system 10, 10.5 illustrated in FIGS. 17-22, one or more of the associated coupler links 120.X incorporate an extendable joint 182, for example, a slideable joint 182′, comprising a prismatic socket 184 on an end of a corresponding first portion 120.A^{X} of the coupler link 120.X, that engages a corresponding tang 186 on a corresponding end of a second portion 120.B^{X} of the coupler link 120.X, wherein the prismatic socket 184 and tang 186 are free to slide with respect to one another responsive to a constraint on the separation between the second 106 and third 108 rotational axes responsive to the positions of the linear actuator 74 acting on the first (upstream-most) end 72.1 of the coupler subassembly 72, and the rotational-positioning actuators 70, 70.1, 70.2, 70.3, 70.4 acting between the coupler links 120.1, 120.2, 120.3, 120.4, 120.5 of the coupler subassembly 72. For example, FIG. 33 illustrates the first 120.A^{X} and second 120.B^{X} portions of the coupler link 120.X, moving into further engagement with one another to a condition of minimum extension, and FIG. 34 illustrates the first 120.A^{X} and second 120.B^{X} portions of the coupler link 120.X, moving out of engagement with one another to a condition with greater extension. The different coupler links 120.X, 120.X+1, and 120.0 are interconnected at corresponding joints 122 that each incorporate associated rotational-positioning actuators 70, 70′, 70″, for example, details of which are illustrated in FIGS. 29-31 and described hereinabove. A terminal first portion 120.A° of a terminal coupler link 120.0 can be adapted to cooperate with either the second-aspect fixedly-located pivot 76, 76″ or the actuator rod 94, but is illustrated in FIGS. 32-34 with a tang 186′.

Accordingly, a variable-stator-vane actuation system 10, 10.1, 10.2, 10.3, 10.4, 10.5 generally comprises: a coupler subassembly 72, 78, 78′, 112, 118 incorporating a plurality of link-coupler portions 78.1, 78.2, 78.3. 78.4, 78.5, 78.A, 78.B, 116, 120, 120.1, 120.2, 120.3, 120.4, 120.5, 120.A, 120.B, 120.0, 120.X, 120.X+1; a first actuator 74 operatively coupled to the coupler subassembly 72, 78, 78′, 112, 118 at a coupling location 97 so as to provide for rotating the coupler subassembly 72, 78, 78′, 112, 118 with respect to a first rotational axis 80, 106 of the coupler subassembly 72, 78, 78′, 112, 118 responsive to an actuation of the first actuator 74, wherein the first actuator 74 is operative relative to a mechanical ground 98; one or more second actuators 70, 70.1, 70.2, 70.3, 70.4, wherein each second actuator 70, 70.1, 70.2, 70.3, 70.4 of the one or more second actuators 70, 70.1, 70.2, 70.3, 70.4 is operative within the coupler subassembly 72, 78, 78′, 112, 118 on at least one link-coupler portion 78.1, 78.2, 78.3. 78.4, 78.5, 78.A, 78.B, 116, 120, 120.1, 120.2, 120.3, 120.4, 120.5, 120.A, 120.B, 120.0, 120.X, 120.X+1 of a corresponding pair of link-coupler portions 78.1-78.2, 78.2-78.3, 78.3-78.4, 78.4-78.5, 78.A-78.B, 116-116, 120.1-120.2, 120.2-120.3, 120.3-120.4, 120.4-120.5, 120.A-120.B, 120.0-120.X, 120.X-120.X+1 of the plurality of link-coupler portions 78.1, 78.2, 78.3. 78.4, 78.5, 78.A, 78.B, 116, 120, 120.1, 120.2, 120.3, 120.4, 120.5, 120.A, 120.B, 120.0, 120.X, 120.X+1, and each the second actuator 70, 70.1, 70.2, 70.3, 70.4 of the one or more second actuators 70, 70.1, 70.2, 70.3, 70.4 provides for a relative motion of t least one link-coupler portion 78.1, 78.2, 78.3. 78.4, 78.5, 78.A, 78.B, 116, 120, 120.1, 120.2, 120.3, 120.4, 120.5, 120.A, 120.B, 120.0, 120.X, 120.X+1 of the corresponding pair of link-coupler portions 78.1-78.2, 78.2-78.3, 78.3-78.4, 78.4-78.5, 78.A-78.B, 116-116, 120.1-120.2, 120.2-120.3, 120.3-120.4, 120.4-120.5, 120.A-120.B, 120.0-120.X, 120.X-120.X+1, relative to a corresponding motion caused by the actuation of the first actuator 74, wherein the relative motion is either additive to, or subtractive from, the corresponding motion responsive to the actuation of the first actuator 74; and at least one first pivot joint 76, 76′, 76″, 84, 84.1, 84.2 of the coupler subassembly 72, 78, 78′, 112, 118, wherein the at least one first pivot joint 76, 76′, 76″, 84, 84.1, 84.2 defines the first rotational axis 80, 106, and the at least one first pivot joint 76, 76′, 76″, 84, 84.1, 84.2 provides for rotationally coupling the coupler subassembly 72, 78, 78′, 112, 118 to the mechanical ground 98. At least one second actuator 70, 70.1, 70.2, 70.3, 70.4 of the one or more second actuators 70, 70.1, 70.2, 70.3, 70.4 may incorporate or cooperate with an associated gear mechanism 150 that provides for torque magnification, and the gear mechanism 150 may comprise a planetary gear train 150, 150′. The first actuator 74 may be a linear actuator 74 selected from an electric-motor-driven linear actuator, an electric-solenoid linear actuator, a fluid-cylinder linear actuator, a fluid-motor-driven linear actuator, a cam-driven-mechanical linear actuator. The one or more second actuators 70, 70.1, 70.2, 70.3, 70.4 is a rotary actuator 70, 70.1, 70.2, 70.3, 70 may be selected from an electrically-powered motor or rotary positioner, an electric stepper motor, a fluid-powered motor or rotary positioner, and an electrically-powered or fluid-powered linear positioner in cooperation with a linear to rotary conversion mechanism.

As illustrated by the first 10.1 and second 10.2 aspects of the variable-stator actuation system 10, 10.1, 10.2, in accordance with one set of embodiments, the coupler subassembly 72, 78, 78′ comprises a plurality of segments 78.1, 78.2, 78.3, 78.4, 78.5 78.A, 78.B, and at least one pair of adjacent segments 78.1-78,2, 78.2-78.3, 78.3-78.4, 78.4-78.5, 78.A-78.B of the plurality of segments 78.1, 78.2, 78.3, 78.4, 78.5 78.A, 78.B, can be rotated with respect to one another about a longitudinal axis 80 of the coupler subassembly 72, 78, 78′ responsive to an actuation by a corresponding second actuator 70, 70.1, 70.2, 70.3, 70.4 of the one or more second actuators 70, 70.1, 70.2, 70.3, 70.4 operative between a corresponding pair of the at least one pair of adjacent segments 78.1-78,2, 78.2-78.3, 78.3-78.4, 78.4-78.5, 78.A-78.B. In accordance with one set of embodiments, at least one segment of the plurality of segments 78.1, 78.2, 78.3, 78.4, 78.5 78.A, 78.B comprises: a tubular structure 78.1, 78.2, 78.3, 78.4, 78.5 78.A, 78.B having a longitudinal rotational axis 80 that defines a corresponding portion of the longitudinal axis 80 of the coupler subassembly 72, 78, 78′; and a corresponding second actuator 70, 70.1, 70.2, 70.3, 70.4 that provides for actuating a corresponding the at least one pair of adjacent segments 78.1-78,2, 78.2-78.3, 78.3-78.4, 78.4-78.5, 78.A-78.B is located within the tubular structure 78. In accordance with one set of embodiments, each link-coupler portion 78.1, 78.2, 78.3. 78.4, 78.5, 78.A, 78.B of the plurality of link-coupler portions 78.1, 78.2, 78.3. 78.4, 78.5, 78.A, 78.B provides for operatively coupling to a corresponding link 62, 62.1, 62.2, 62.3, 62.4, 62.5 via a corresponding associated joint 136, 136³, 136¹′, 136¹″ having at least one rotational degree of freedom, when connected to the link-coupler portion 78.1, 78.2, 78.3. 78.4, 78.5, 78.A, 78.B, the corresponding link 62, 62.1, 62.2, 62.3, 62.4, 62.5 provides for controlling rotational angles of a corresponding plurality of stator vanes 14, 14.1 of a compressor portion 18 of a gas turbine engine 12, 12′, and the link-coupler portion 78.1, 78.2, 78.3. 78.4, 78.5, 78.A, 78.B is operatively coupled to, or depends from, an external surface of a corresponding segment 78.1, 78.2, 78.3, 78.4, 78.5 78.A, 78.B of the plurality of segments 78.1, 78.2, 78.3, 78.4, 78.5 78.A, 78.B of the coupler subassembly 72, 78, 78′.

As illustrated by the first 10.1 and fourth 10.4 aspects of the variable-stator actuation system 10, 10.1, 10.4, in accordance with one set of embodiments, the first rotational axis 80 is coincident with a longitudinal axis 80 of the coupler subassembly 72, 78, 112, the at least one first pivot joint 76, 76′, 84, 84.1, 84.2 comprises a pair of first pivot joints 76, 76′, 84, 84.1, 84.2 that straddle the coupler subassembly 72, 78, 112, and corresponding respective associated rotational axes 80 of each of the pair of first pivot joints 76, 76′, 84, 84.1, 84.2 are coincident with one another and with the first rotational axis 80.

As illustrated by the third 10.3 and fourth 10.4 aspects of the variable-stator actuation system 10, 10.3, 10.4, in accordance with one set of embodiments, the coupler subassembly 72, 112 comprises a frame 114, at least one second actuator 70, 70.1, 70.2, 70.3, 70.4 of the one or more second actuators 70, 70.1, 70.2, 70.3, 70.4 is operatively coupled to the frame 114, and for each the at least one second actuator 70, 70.1, 70.2, 70.3, 70.4, a corresponding link-coupler portion 116 is actuated by the at least one second actuator 70, 70.1, 70.2, 70.3, 70.4, and the corresponding link-coupler portion 116 is movable relative to the frame 114. In accordance with one set of embodiments, the frame 114 comprises a tubular structure 114, the one or more second actuators 70, 70.1, 70.2, 70.3, 70.4 are located within the tubular structure 114, and for each the one or more second actuators 70, 70.1, 70.2, 70.3, 70.4 located within the tubular structure 114, the frame 114 incorporates a corresponding opening 117 through which a corresponding link-coupler portion 116 extends and within which the corresponding link-coupler portion 116 can move. In accordance with one set of embodiments, each link-coupler portion 116 of the plurality of link-coupler portions 116 provides for operatively coupling to a corresponding link 62, 62.1, 62.2, 62.3, 62.4, 62.5 via a corresponding associated joint having at least one rotational degree of freedom, when connected to the link-coupler portion 116, the corresponding link 62, 62.1, 62.2, 62.3, 62.4, 62.5 provides for controlling rotational angles of a corresponding plurality of stator vanes 14, 14.1 of a compressor portion 18 of a gas turbine engine 12, 12′, and the link-coupler portion 116 is operatively coupled to, or depends from, a portion of a corresponding second actuator 70, 70.1, 70.2, 70.3, 70.4 of the one or more second actuators 70, 70.1, 70.2, 70.3, 70.4 that moves relative to the frame 114 during actuation of the corresponding second actuator 70, 70.1, 70.2, 70.3, 70.4.

As illustrated by the second aspect 10.2 of the variable-stator actuation system 10, 10.2, in accordance with one set of embodiments, further comprises a second pivot joint 84 operatively coupled to the at least one first pivot joint, 76, 76′, 76″, wherein a rotational axis 80 of the second pivot joint 84 is coincident with the longitudinal axis 80 of the coupler subassembly 72, and the second pivot joint 84 cooperates with a shaft portion 82 extending from an adjacent segment 78.5 of the plurality of segments 78.1, 78.2, 78.3. 78.4, 78.5, 78.A, 78.B of the coupler subassembly 72 so as to provide for the adjacent segment 78.5 of the coupler subassembly 72 to rotate about the longitudinal axis 80 of the coupler subassembly 72 responsive to an actuation of at least one second actuator 70, 70.1, 70.2, 70.3, 70.4 of the one or more second actuators 70, 70.1, 70.2, 70.3, 70.4.

As illustrated by the second 10.2, third 10.3 and fifth 10.5 aspects of the variable-stator actuation system 10, 10.2, 10.3, 10.5, in accordance with one set of embodiments, the first rotational axis 106 is substantially normal to a plane 104 containing a longitudinal axis 80, 188 of at least a portion of the coupler subassembly 72, 78′, 112, 118.

As illustrated by the second 10.2 and fifth 10.5 aspects of the variable-stator actuation system 10, 10.2, 10.5, in accordance with one set of embodiments, at least one of the plurality of link-coupler portions 78.5, 120.1-120.2, 120.2-120.3, 120.3-120.4, 120.4-120.5, 120.A-120.B, 120.0-120.X, -120.X-120.X+1 incorporates an extendable joint 182, 182′ that provides for maintaining a projected length between the coupling location 97 of the first actuator 74 and the at least one first pivot joint 76, 76″ during operation of the variable-stator-vane actuation system 10, 10.2, 10.5.

As illustrated by the fifth aspect 10.5 of the variable-stator actuation system 10, 10.5, in accordance with one set of embodiments, the coupler subassembly 72, 118 comprises a plurality of segments 120, 120.0, 120.1, 120.2, 120.3, 120.4, 120.5, 120.A, 120.B, 120.X, 120.X+1, and at least one pair of adjacent segments 120.1-120.2, 120.2-120.3, 120.3-120.4, 120.4-120.5, 120.A-120.B, 120.0-120.X, 120.X-120.X+2 of the plurality of segments 120, 120.0, 120.1, 120.2, 120.3, 120.4, 120.5, 120.A, 120.B, 120.X, 120.X+1 can be rotated with respect to one another about a corresponding axis 130.1, 130.2, 130.3, 130.4 that is substantially parallel to the first rotational axis 106 of the coupler subassembly 72, 118 responsive to an actuation by a corresponding second actuator 70, 70.1, 70.2, 70.3, 70.4 of the one or more second actuators 70, 70.1, 70.2, 70.3, 70.4 operative between the at least one pair of adjacent segments 120.1-120.2, 120.2-120.3, 120.3-120.4, 120.4-120.5, 120.A-120.B, 120.0-120.X, 120.X-120.X+2. In accordance with one set of embodiments, each link-coupler portion 120, 120.1, 120.2, 120.3, 120.4, 120.5, 120.A, 120.B, 120.0, 120.X, 120.X+1 of the plurality of link-coupler portions 120, 120.1, 120.2, 120.3, 120.4, 120.5, 120.A, 120.B, 120.0, 120.X, 120.X+1 provides for operatively coupling to a corresponding link 62, 62.1, 62.2, 62.3, 62.4, 62.5 via a corresponding associated joint 136, 136³ having at least one rotational degree of freedom, when connected to the link-coupler portion 120, 120.1, 120.2, 120.3, 120.4, 120.5, 120.A, 120.B, 120.0, 120.X, 120.X+1, the corresponding link 62, 62.1, 62.2, 62.3, 62.4, 62.5 provides for controlling rotational angles of a corresponding plurality of stator vanes 14, 14.1 of a compressor portion 18 of a gas turbine engine 12, 12′, and the link-coupler portion 120, 120.1, 120.2, 120.3, 120.4, 120.5, 120.A, 120.B, 120.0, 120.X, 120.X+1 is operatively coupled to, or depends from, an external surface of a corresponding segment 120, 120.0, 120.1, 120.2, 120.3, 120.4, 120.5, 120.A, 120.B, 120.X, 120.X+1 of the plurality of segments 120, 120.0, 120.1, 120.2, 120.3, 120.4, 120.5, 120.A, 120.B, 120.X, 120.X+1 of the coupler subassembly 72, 118. In accordance with one set of embodiments, at least one pair of adjacent segments 120.1-120.2, 120.2-120.3, 120.3-120.4, 120.4-120.5, 120.A-120.B, 120.0-120.X, 120.X-120.X+1 of the plurality of segments 120, 120.1, 120.2, 120.3, 120.4, 120.5, 120.A, 120.B, 120.0, 120.X, 120.X+1 of the coupler subassembly 72, 118 interlock with one another at an associated joint 122.1, 122.2. 122.3, 122.4 that provides for rotation relative to one another about a corresponding second rotational axis 130.1, 130.2, 130.3, 130.4, the corresponding second rotational axis 130.1, 130.2, 130.3, 130 is substantially parallel to the first rotational axis 106, a corresponding associated the second actuator 70, 70.1, 70.2, 70.3, 70.4 is operative across the associated joint 122.1, 122.2. 122.3, 122.4, and the first rotational axis 106 is substantially normal to a plane 104 containing a longitudinal axis 188 of at least one segment of the plurality of segments 120.1-120.2, 120.2-120.3, 120.3-120.4, 120.4-120.5, 120.A-120.B, 120.0-120.X, 120.X-120.X+1 of the coupler subassembly 72, 118.

Furthermore, a method of controlling rotation angles of each of a plurality of stator vanes 14, 14.1 of a gas turbine engine 12, 12′ generally comprises: operatively coupling a first group of stator vanes 16.1, 16.2, 16.3, 16.4, 16.5, 16.i, 16.j to a corresponding first link-coupler portion 78.1, 78.2, 78.3. 78.4, 78.5, 78.A, 78.B, 116, 120, 120.1, 120.2, 120.3, 120.4, 120.5, 120.A, 120.B, 120.0, 120.X, 120.X+1 of a coupler subassembly 72, 78, 78′, 112, 118, wherein a rotational position of each stator vane 14, 14.1 of the first group of stator vanes 16.1, 16.2, 16.3, 16.4, 16.5, 16.i, 16.s is responsive to a position of the corresponding first link-coupler portion 78.1, 78.2, 78.3. 78.4, 78.5, 78.A, 78.B, 116, 120, 120.1, 120.2, 120.3, 120.4, 120.5, 120.A, 120.B, 120.0, 120.X, 120.X+1 of the coupler subassembly 72, 78, 78′, 112, 118; operatively coupling a second group of stator vanes 16.1, 16.2, 16.3, 16.4, 16.5, 16.i, 16.j to a corresponding second link-coupler portion 78.1, 78.2, 78.3. 78.4, 78.5, 78.A, 78.B, 116, 120, 120.1, 120.2, 120.3, 120.4, 120.5, 120.A, 120.B, 120.0, 120.X, 120.X+1 of the coupler subassembly 72, 78, 78′, 112, 118, wherein a rotational position of each stator vane 14, 14.1 of the second group of stator vanes 16.1, 16.2, 16.3, 16.4, 16.5, 16.i, 16.j is responsive to a position of the corresponding second link-coupler portion 78.1, 78.2, 78.3. 78.4, 78.5, 78.A, 78.B, 116, 120, 120.1, 120.2, 120.3, 120.4, 120.5, 120.A, 120.B, 120.0, 120.X, 120.X+1 of the coupler subassembly 72, 78, 78′, 112, 118; setting a rotational position of the coupler subassembly 72, 78, 78′, 112, 118 about a first rotational axis 80, 106 responsive to a position of a first actuator 74, wherein each of the position of the corresponding first link-coupler portion 78.1, 78.2, 78.3. 78.4, 78.5, 78.A, 78.B, 116, 120, 120.1, 120.2, 120.3, 120.4, 120.5, 120.A, 120.B, 120.0, 120.X, 120.X+1 and the position of the corresponding second link-coupler portion 78.1, 78.2, 78.3. 78.4, 78.5, 78.A, 78.B, 116, 120, 120.1, 120.2, 120.3, 120.4, 120.5, 120.A, 120.B, 120.0, 120.X, 120.X+1 is responsive to the rotational position of the coupler subassembly 72, 78, 78′, 112, 118 responsive to the position of the first actuator 74; and setting a relative position of the corresponding first link-coupler portion 78.1, 78.2, 78.3. 78.4, 78.5, 78.A, 78.B, 116, 120, 120.1, 120.2, 120.3, 120.4, 120.5, 120.A, 120.B, 120.0, 120.X, 120.X+1 of the coupler subassembly 72, 78, 78′, 112, 118 relative to that of the corresponding second link-coupler portion 78.1, 78.2, 78.3. 78.4, 78.5, 78.A, 78.B, 116, 120, 120.1, 120.2, 120.3, 120.4, 120.5, 120.A, 120.B, 120.0, 120.X, 120.X+1 of the coupler subassembly 72, 78, 78′, 112, 118, responsive to a position of a second actuator 70, 70.1, 70.2, 70.3, 70.4. The first actuator 74 may comprise a linear actuator 74, and the operation of setting the rotational position of the coupler subassembly 72, 78, 78′, 112, 118 about the first rotational axis 80, 106 responsive to the position of a first actuator 74 comprises either extending or retracting an actuator rod 94 of the first actuator 74. The method may further comprise operatively coupling one or more additional groups of stator vanes 16.1, 16.2, 16.3, 16.4, 16.5, 16.i, 16.j to a corresponding one or more additional link-coupler portions 78.1, 78.2, 78.3. 78.4, 78.5, 78.A, 78.B, 116, 120, 120.1, 120.2, 120.3, 120.4, 120.5, 120.A, 120.B, 120.0, 120.X, 120.X+1 of the coupler subassembly 72, 78, 78′, 112, 118, wherein a rotational position of each stator vane of the one or more additional groups of stator vanes is responsive to a corresponding position of the additional of the coupler subassembly 72, 78, 78′, 112, 118, and each the corresponding position of the corresponding one or more additional link-coupler portions 78.1, 78.2, 78.3. 78.4, 78.5, 78.A, 78.B, 116, 120, 120.1, 120.2, 120.3, 120.4, 120.5, 120.A, 120.B, 120.0, 120.X, 120.X+1 of the coupler subassembly 72, 78, 78′, 112, 118 is responsive to the rotational position of the coupler subassembly 72, 78, 78′, 112, 118 responsive to the position of the first actuator 74; and setting a relative position of the corresponding one or more additional link-coupler portions 78.1, 78.2, 78.3. 78.4, 78.5, 78.A, 78.B, 116, 120, 120.1, 120.2, 120.3, 120.4, 120.5, 120.A, 120.B, 120.0, 120.X, 120.X+1 of the coupler subassembly 72, 78, 78′, 112, 118 relative to one or more link-coupler portions selected from another of the corresponding one or more additional link-coupler portions 78.1, 78.2, 78.3. 78.4, 78.5, 78.A, 78.B, 116, 120, 120.1, 120.2, 120.3, 120.4, 120.5, 120.A, 120.B, 120.0, 120.X, 120.X+1 of the coupler subassembly 72, 78, 78′, 112, 118, the corresponding first link-coupler portion 78.1, 78.2, 78.3. 78.4, 78.5, 78.A, 78.B, 116, 120, 120.1, 120.2, 120.3, 120.4, 120.5, 120.A, 120.B, 120.0, 120.X, 120.X+1 of the coupler subassembly 72, 78, 78′, 112, 118, and the corresponding second link-coupler portion 78.1, 78.2, 78.3. 78.4, 78.5, 78.A, 78.B, 116, 120, 120.1, 120.2, 120.3, 120.4, 120.5, 120.A, 120.B, 120.0, 120.X, 120.X+1 of the coupler subassembly 72, 78, 78′, 112, 118, responsive to one or more corresponding positions of one or more corresponding additional second actuators 70, 70.1, 70.2, 70.3, 70.4.

As illustrated by the first 10.1 and fourth 10.4 aspects of the variable-stator actuation system 10, 10.1, 10.4, in accordance with one set of embodiments, the coupler subassembly 72, 78, 112 incorporates at least one structural segment 78.1, 78.2, 78.3. 78.4, 78.5, 78.A, 78.B, 114 along a common longitudinal axis 80, and the first rotational axis 80 is coincident with the common longitudinal axis 80. As illustrated by the first aspect 10.1 of the variable-stator actuation system 10, 10.1, in accordance with one set of embodiments, the corresponding first and second link-coupler portions 78.1, 78.2, 78.3. 78.4, 78.5, 78.A, 78.B of the coupler subassembly 72, 78 are associated with corresponding first and second segments 78.1, 78.2, 78.3. 78.4, 78.5, 78.A, 78.B of the coupler subassembly 72, 78 that share the common longitudinal axis 80, and the operation of setting the relative position of the corresponding first link-coupler portion 78.1, 78.2, 78.3. 78.4, 78.5, 78.A, 78.B of the coupler subassembly 72, 78 relative to that of the corresponding second link-coupler portion 78.1, 78.2, 78.3. 78.4, 78.5, 78.A, 78.B of the coupler subassembly 72, 78 comprises relatively rotating the corresponding first and second segments 78.1, 78.2, 78.3. 78.4, 78.5, 78.A, 78.B of the coupler subassembly 72, 78 about the common longitudinal axis 80 relative to one another responsive to a position of the second actuator 70, 70.1, 70.2, 70.3, 70.4. As illustrated by the fourth aspect 10.4 of the variable-stator actuation system 10, 10.4, in accordance with one set of embodiments, the corresponding first and second link-coupler portions 116 of the coupler subassembly 72, 112 are associated with corresponding separate second actuators 70, 70.1, 70.2, 70.3, 70. of the coupler subassembly 72, 112, each of which is operatively coupled to a frame 114 of the coupler subassembly 72, 112, and the operation of setting the relative position of the corresponding first link-coupler portion 116 of the coupler subassembly 72, 112 relative to that of the corresponding second link-coupler portion 116 of the coupler subassembly 72, 112 comprises independently controlling one or both of the corresponding separate second actuators 70, 70.1, 70.2, 70.3, 70.

As illustrated by the second 10.2 and third 10.3 aspects of the variable-stator actuation system 10, 10.2, 10.3, in accordance with one set of embodiments, the coupler subassembly 72, 78′, 112 incorporates at least one structural segment 78.1, 78.2, 78.3. 78.4, 78.5, 78.A, 78.B, 114 along a common longitudinal axis 80, and the first rotational axis 106 is substantially normal to the common longitudinal axis 80. As illustrated by the second aspect 10.2 of the variable-stator actuation system 10, 10.2, in accordance with one set of embodiments, the corresponding first and second link-coupler portions 78.1, 78.2, 78.3. 78.4, 78.5, 78.A, 78.B of the coupler subassembly 72, 78′ are associated with corresponding first and second segments 78.1, 78.2, 78.3. 78.4, 78.5, 78.A, 78.B of the coupler subassembly 72, 78′ that share the common longitudinal axis 80, and the operation of setting the relative position of the corresponding first link-coupler portion 78.1, 78.2, 78.3. 78.4, 78.5, 78.A, 78.B of the coupler subassembly 72, 78′ relative to that of the corresponding second link-coupler portion 78.1, 78.2, 78.3. 78.4, 78.5, 78.A, 78.B of the coupler subassembly 72, 78′ comprises relatively rotating the corresponding first and second segments 78.1, 78.2, 78.3. 78.4, 78.5, 78.A, 78.B of the coupler subassembly 72, 78′ about the common longitudinal axis 80 relative to one another responsive to a position of the second actuator 70, 70.1, 70.2, 70.3, 70.4. As illustrated by the third aspect 10.3 of the variable-stator actuation system 10, 10.3, in accordance with one set of embodiments, the corresponding first and second link-coupler portions 78.1, 78.2, 78.3. 78.4, 78.5, 78.A, 78.B of the coupler subassembly 72, 112 are associated with corresponding separate second actuators 70, 70.1, 70.2, 70.3, 70.4 of the coupler subassembly 72, 112, each of which is operatively coupled to a frame 114 of the coupler subassembly 72, 112, and the operation of setting the relative position of the corresponding first link-coupler portion 78.1, 78.2, 78.3. 78.4, 78.5, 78.A, 78.B of the coupler subassembly 72, 112 relative to that of the corresponding second link-coupler portion 78.1, 78.2, 78.3. 78.4, 78.5, 78.A, 78.B of the coupler subassembly 72, 112 comprises independently controlling one or both of the corresponding separate second actuators 70, 70.1, 70.2, 70.3, 70.

As illustrated by the second 10.2, third 10.3, and fifth 10.5 aspects of the variable-stator actuation system 10, 10.2, 10.3, 10.5, in accordance with one set of embodiments, the corresponding first and second link-coupler portions 78.1, 78.2, 78.3. 78.4, 78.5, 78.A, 78.B, 116, 120, 120.1, 120.2, 120.3, 120.4, 120.5, 120.A, 120.B, 120.0, 120.X, 120.X+1 are coupled end-to-end so as to form a chain of link-coupler portions 78.1-78.2-78.3-78.4-78.5, 116-116, 120.1-120.2-120.3-120.4-120.5, 120.A-120.B, 120.0-120.X-120.X+1, and the first rotational axis 106 is substantially normal to a line between first and second ends of the chain of link-coupler portions 78.1-78.2-78.3-78.4-78.5, 116-116, 120.1-120.2-120.3-120.4-120.5, 120.A-120.B, 120.0-120.X-120.X+1.

As illustrated by the fifth aspect 10.5 of the variable-stator actuation system 10, 10.5, in accordance with one set of embodiments, an end-to-end coupling of the corresponding first and second link-coupler portions 120, 120.1, 120.2, 120.3, 120.4, 120.5, 120.A, 120.B, 120.0, 120.X, 120.X+1 comprises a corresponding joint 122.1, 122.2. 122.3, 122.4 having a corresponding rotational axis 130.1, 130.2, 130.3, 130.4 that is substantially parallel to the first rotational axis 106, and the operation of setting the relative position of the corresponding first link-coupler portion 120, 120.1, 120.2, 120.3, 120.4, 120.5, 120.A, 120.B, 120.0, 120.X, 120.X+1 of the coupler subassembly 72, 118 relative to that of the corresponding second link-coupler portion 120, 120.1, 120.2, 120.3, 120.4, 120.5, 120.A, 120.B, 120.0, 120.X, 120.X+1 of the coupler subassembly 72, 118 comprises rotating the corresponding first and second link-coupler portions 120, 120.1, 120.2, 120.3, 120.4, 120.5, 120.A, 120.B, 120.0, 120.X, 120.X+1 relative to one another about the corresponding rotational axis 130.1, 130.2, 130.3, 130.4 of the corresponding joint 122.1, 122.2. 122.3, 122.4.

While specific embodiments have been described in detail in the foregoing detailed description and illustrated in the accompanying drawings, those with ordinary skill in the art will appreciate that various modifications and alternatives to those details could be developed in light of the overall teachings of the disclosure. It should be understood, that any reference herein to the term “or” is intended to mean an “inclusive or” or what is also known as a “logical OR”, wherein when used as a logic statement, the expression “A or B” is true if either A or B is true, or if both A and B are true, and when used as a list of elements, the expression “A, B or C” is intended to include all combinations of the elements recited in the expression, for example, any of the elements selected from the group consisting of A, B, C, (A, B), (A, C), (B, C), and (A, B, C); and so on if additional elements are listed. Furthermore, it should also be understood that the indefinite articles “a” or “an”, and the corresponding associated definite articles “the” or “said”, are each intended to mean one or more unless otherwise stated, implied, or physically impossible. Yet further, it should be understood that the expressions “at least one of A and B, etc.”, “at least one of A or B, etc.”, “selected from A and B, etc.” and “selected from A or B, etc.” are each intended to mean either any recited element individually or any combination of two or more elements, for example, any of the elements from the group consisting of “A”, “B”, and “A AND B together”, etc. Yet further, it should be understood that the expressions “one of A and B, etc.” and “one of A or B, etc.” are each intended to mean any of the recited elements individually alone, for example, either A alone or B alone, etc., but not A AND B together. Furthermore, it should also be understood that unless indicated otherwise or unless physically impossible, that the above-described embodiments and aspects can be used in combination with one another and are not mutually exclusive. Accordingly, the particular arrangements disclosed are meant to be illustrative only and not limiting as to the scope of the invention, which is to be given the full breadth of the appended claims, and any and all equivalents thereof.

What is claimed is:

1. A variable-stator-vane actuation system, comprising:
a. a coupler subassembly incorporating a plurality of link-coupler portions;
b. a first actuator operatively coupled to said coupler subassembly at a coupling location so as to provide for rotating said coupler subassembly with respect to a first rotational axis of said coupler subassembly responsive to an actuation of said first actuator, wherein said first actuator is operative relative to a mechanical ground;
c. one or more second actuators, wherein each second actuator of said one or more second actuators is operative within said coupler subassembly on at least one link-coupler portion of a corresponding pair of link-coupler portions of said plurality of link-coupler portions, and each said second actuator of said one or more second actuators provides for a relative motion of at least one link-coupler portion of said corresponding pair of link-coupler portions, relative to a corresponding motion caused by said actuation of said first actuator, wherein said relative motion is either additive to, or subtractive from, said corresponding motion responsive to said actuation of said first actuator; and
d. at least one first pivot joint of said coupler subassembly, wherein said at least one first pivot joint defines said first rotational axis, and said at least one first pivot joint provides for rotationally coupling said coupler subassembly to said mechanical ground.

2. A variable-stator-vane actuation system as recited in claim 1, wherein said coupler subassembly comprises a plurality of segments, and at least one pair of adjacent segments of said plurality of segments can be rotated with respect to one another about a longitudinal axis of said coupler subassembly responsive to an actuation by a corresponding second actuator of said one or more second actuators operative between a corresponding pair of said at least one pair of adjacent segments.

3. A variable-stator-vane actuation system as recited in claim 2, wherein at least one segment of said plurality of segments comprises: a tubular structure having a longitudinal rotational axis that defines a corresponding portion of said longitudinal axis of said coupler subassembly; and a corresponding said second actuator that provides for actuating a corresponding said at least one pair of adjacent segments is located within said tubular structure.

4. A variable-stator-vane actuation system as recited in claim 1, wherein said coupler subassembly comprises a frame, at least one second actuator of said one or more second actuators is operatively coupled to said frame, and for each said at least one second actuator, a corresponding link-coupler portion is actuated by said at least one second actuator, and said corresponding link-coupler portion is movable relative to said frame.

5. A variable-stator-vane actuation system as recited in claim 4, wherein said frame comprises a tubular structure, said one or more second actuators are located within said tubular structure, and for each said one or more second actuators located within said tubular structure, said frame incorporates a corresponding opening through which a corresponding link-coupler portion extends and within which said corresponding link-coupler portion can move.

6. A variable-stator-vane actuation system as recited in claim 1, wherein said coupler subassembly comprises a plurality of segments, and at least one pair of adjacent segments of said plurality of segments can be rotated with respect to one another about a corresponding axis that is substantially parallel to said first rotational axis of said coupler subassembly responsive to an actuation by a corresponding second actuator of said one or more second actuators operative between said at least one pair of adjacent segments.

7. A variable-stator-vane actuation system as recited in claim 2, wherein each link-coupler portion of said plurality of link-coupler portions provides for operatively coupling to a corresponding link via a corresponding associated joint having at least one rotational degree of freedom, when connected to said link-coupler portion, said corresponding link provides for controlling rotational angles of a corresponding plurality of stator vanes of a compressor portion of a gas turbine engine, and said link-coupler portion is operatively coupled to, or depends from, an external surface of a corresponding segment of said plurality of segments of said coupler subassembly.

8. A variable-stator-vane actuation system as recited in claim 6, wherein each link-coupler portion of said plurality of link-coupler portions provides for operatively coupling to a corresponding link via a corresponding associated joint having at least one rotational degree of freedom, when connected to said link-coupler portion, said corresponding link provides for controlling rotational angles of a corresponding plurality of stator vanes of a compressor portion of a gas turbine engine, and said link-coupler portion is operatively coupled to, or depends from, an external surface of a corresponding segment of said plurality of segments of said coupler subassembly.

9. A variable-stator-vane actuation system as recited in claim 4, wherein each link-coupler portion of said plurality of link-coupler portions provides for operatively coupling to a corresponding link via a corresponding associated joint having at least one rotational degree of freedom, when connected to said link-coupler portion, said corresponding link provides for controlling rotational angles of a corresponding plurality of stator vanes of a compressor portion of a gas turbine engine, and said link-coupler portion is operatively coupled to, or depends from, a portion of a corresponding second actuator of said one or more second actuators that moves relative to said frame during actuation of said corresponding second actuator.

10. A variable-stator-vane actuation system as recited in claim 1, wherein said first rotational axis is coincident with a longitudinal axis of said coupler subassembly, said at least one first pivot joint comprises a pair of first pivot joints that straddle said coupler subassembly, and corresponding respective associated rotational axes of each of said pair of first pivot joints are coincident with one another and with said first rotational axis.

11. A variable-stator-vane actuation system as recited in claim 1, wherein said first rotational axis is substantially normal to a plane containing a longitudinal axis of at least a portion of said coupler subassembly.

12. A variable-stator-vane actuation system as recited in claim 6, wherein at least one pair of adjacent segments of said plurality of segments of said coupler subassembly interlock with one another at an associated joint that provides for rotation relative to one another about a corresponding second rotational axis, said corresponding second rotational axis is substantially parallel to said first rotational axis, a corresponding associated said second actuator is operative across said associated joint, and said first rotational axis is substantially normal to a plane containing a longitudinal axis of at least one segment of said plurality of segments of said coupler subassembly.

13. A variable-stator-vane actuation system as recited in claim 2, further comprising a second pivot joint operatively coupled to said at least one first pivot joint, wherein a rotational axis of said second pivot joint is coincident with said longitudinal axis of said coupler subassembly, and said second pivot joint cooperates with a shaft portion extending from an adjacent segment of said plurality of segments of said coupler subassembly so as to provide for said adjacent segment of said coupler subassembly to rotate about said longitudinal axis of said coupler subassembly responsive to an actuation of at least one second actuator of said one or more second actuators.

14. A variable-stator-vane actuation system as recited in claim 1, wherein at least one second actuator of said one or more second actuators incorporates or cooperates with an associated gear mechanism that provides for torque magnification.

15. A variable-stator-vane actuation system as recited in claim 14, wherein said associated gear mechanism comprises a planetary gear train.

16. A variable-stator-vane actuation system as recited in claim 1, wherein said first actuator is a linear actuator selected from an electric-motor-driven linear actuator, an electric-solenoid linear actuator, a fluid-cylinder linear actuator, a fluid-motor-driven linear actuator, a cam-driven-mechanical linear actuator.

17. A variable-stator-vane actuation system as recited in claim 1, wherein said one or more second actuators is a rotary actuator selected from an electrically-powered motor or rotary positioner, an electric stepper motor, a fluid-powered motor or rotary positioner, and an electrically-powered or fluid-powered linear positioner in cooperation with a linear to rotary conversion mechanism.

18. A variable-stator-vane actuation system as recited in claim 1, wherein at least one of said plurality of link-coupler portions incorporates an extendable joint that provides for maintaining a projected length between said coupling location of said first actuator and said at least one first pivot joint during operation of the variable-stator-vane actuation system.

19. A method of controlling rotation angles of each of a plurality of stator vanes of a gas turbine engine, comprising:
a. operatively coupling a first group of stator vanes to a corresponding first link-coupler portion of a coupler subassembly, wherein a rotational position of each stator vane of said first group of stator vanes is responsive to a position of said corresponding first link-coupler portion of said coupler subassembly;
b. operatively coupling a second group of stator vanes to a corresponding second link-coupler portion of said coupler subassembly, wherein a rotational position of each stator vane of said second group of stator vanes is responsive to a position of said corresponding second link-coupler portion of said coupler subassembly;
c. setting a rotational position of said coupler subassembly about a first rotational axis responsive to a position of a first actuator, wherein each of said position of said corresponding first link-coupler portion and said position of said corresponding second link-coupler portion is responsive to said rotational position of said coupler subassembly responsive to said position of said first actuator; and
d. setting a relative position of said corresponding first link-coupler portion of said coupler subassembly relative to that of said corresponding second link-coupler portion of said coupler subassembly, responsive to a position of a second actuator.

20. A method of controlling rotation angles of each of a plurality of stator vanes of a gas turbine engine as recited in claim 19, wherein said coupler subassembly incorporates at least one structural segment along a common longitudinal axis, and said first rotational axis is coincident with said common longitudinal axis.

21. A method of controlling rotation angles of each of a plurality of stator vanes of a gas turbine engine as recited in claim 19, wherein said coupler subassembly incorporates at least one structural segment along a common longitudinal axis, and said first rotational axis is substantially normal to said common longitudinal axis.

22. A method of controlling rotation angles of each of a plurality of stator vanes of a gas turbine engine as recited in claim 19, wherein said corresponding first and second link-coupler portions are coupled end-to-end so as to form a chain of link-coupler portions, and said first rotational axis is substantially normal to a line between first and second ends of said chain of link-coupler portions.

23. A method of controlling rotation angles of each of a plurality of stator vanes of a gas turbine engine as recited in claim 19, wherein said first actuator comprises a linear actuator, and the operation of setting said rotational position of said coupler subassembly about said first rotational axis responsive to said position of a first actuator comprises either extending or retracting an actuator rod of said first actuator.

24. A method of controlling rotation angles of each of a plurality of stator vanes of a gas turbine engine as recited in claim 20, wherein said corresponding first and second link-coupler portions of said coupler subassembly are associated with corresponding first and second segments of said coupler subassembly that share said common longitudinal axis, and the operation of setting said relative position of said corresponding first link-coupler portion of said coupler subassembly relative to that of said corresponding second link-coupler portion of said coupler subassembly comprises relatively rotating said corresponding first and second segments of said coupler subassembly about said common longitudinal axis relative to one another responsive to a position of said second actuator.

25. A method of controlling rotation angles of each of a plurality of stator vanes of a gas turbine engine as recited in claim 21, wherein said corresponding first and second link-coupler portions of said coupler subassembly are associated with corresponding first and second segments of said coupler subassembly that share said common longitudinal axis, and the operation of setting said relative position of said corresponding first link-coupler portion of said coupler subassembly relative to that of said corresponding second link-coupler portion of said coupler subassembly comprises relatively rotating said corresponding first and second segments of said coupler subassembly about said common longitudinal axis relative to one another responsive to a position of said second actuator.

26. A method of controlling rotation angles of each of a plurality of stator vanes of a gas turbine engine as recited in claim 20, wherein said corresponding first and second link-coupler portions of said coupler subassembly are associated with corresponding separate second actuators of said coupler subassembly, each of which is operatively coupled to a frame of said coupler subassembly, and the operation of setting said relative position of said corresponding first link-coupler portion of said coupler subassembly relative to that of said corresponding second link-coupler portion of said coupler subassembly comprises independently controlling one or both of said corresponding separate second actuators.

27. A method of controlling rotation angles of each of a plurality of stator vanes of a gas turbine engine as recited in claim 21, wherein said corresponding first and second link-coupler portions of said coupler subassembly are associated with corresponding separate second actuators of said coupler subassembly, each of which is operatively coupled to a frame of said coupler subassembly, and the operation of setting said relative position of said corresponding first link-coupler portion of said coupler subassembly relative to that of said corresponding second link-coupler portion of said coupler subassembly comprises independently controlling one or both of said corresponding separate second actuators.

28. A method of controlling rotation angles of each of a plurality of stator vanes of a gas turbine engine as recited in claim 22, wherein an end-to-end coupling of said corresponding first and second link-coupler portions comprises a corresponding joint having a corresponding rotational axis that is substantially parallel to said first rotational axis, and the operation of setting said relative position of said corresponding first link-coupler portion of said coupler subassembly relative to that of said corresponding second link-coupler portion of said coupler subassembly comprises rotating said corresponding first and second link-coupler portions relative to one another about said corresponding rotational axis of said corresponding joint.

29. A method of controlling rotation angles of each of a plurality of stator vanes of a gas turbine engine as recited in claim 19, further comprising:
a. operatively coupling one or more additional groups of stator vanes to a corresponding one or more additional link-coupler portions of said coupler subassembly, wherein a rotational position of each stator vane of said one or more additional groups of stator vanes is responsive to a corresponding position of said additional of said coupler subassembly, and each said corresponding position of said corresponding one or more additional link-coupler portions of said coupler subassembly is responsive to said rotational position of said coupler subassembly responsive to said position of said first actuator; and
b. setting a relative position of said corresponding one or more additional link-coupler portions of said coupler subassembly relative to one or more link-coupler portions selected from another of said corresponding one or more additional link-coupler portions of said coupler subassembly, said corresponding first link-coupler portion of said coupler subassembly, and said corresponding second link-coupler portion of said coupler subassembly, responsive to one or more corresponding positions of one or more corresponding additional second actuators.
